(19) United States
(12) Patent Application Publication
(10) Pub. No.: US 2018/0158160 A1
(43) Pub. Date: Jun. 7, 2018

(54) INTERNET BASED METHOD AND SYSTEM FOR WORLDWIDE PROMOTING AND OFFERING FOR SALE OR LICENSE PATENT RIGHTS AND PATENT APPLICATION RIGHTS

(71) Applicant: PCTXS INC., Wolfville (CA)

(72) Inventors: Philip Brian KERR, Wolfville (CA); Juergen FUCHS, Verona (CA); Robin Timothy CROUCH, Port Williams (CA)

(21) Appl. No.: 15/576,019

(22) PCT Filed: May 17, 2016
(86) PCT No.: PCT/CA2016/000148

§ 371 Date: Nov. 21, 2017

(30) Foreign Application Priority Data
May 22, 2015 (CA) 2,892,782
Sep. 23, 2015 (CA) 2,905,362
Oct. 19, 2015 (CA) 2,909,107
Oct. 19, 2015 (CA) 2,909,275
Oct. 19, 2015 (CA) 2,909,336
Oct. 19, 2015 (CA) 2,909,337
Nov. 3, 2015 (CA) 2,911,065
Nov. 3, 2015 (CA) 2,911,128
Dec. 10, 2015 (CA) 2,914,588

(51) Int. Cl. G06Q 50/18; G06Q 40/04; G06Q 40/06; G06Q 30/02; G06F 17/30

(52) U.S. Cl. CPC G06Q 50/184; G06Q 40/04; G06F 17/30867; G06Q 30/0273; G06Q 40/06

(57) ABSTRACT

An Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications are provided. A server computer is connected to the Internet. A patent application database is connected to the server computer. The patent application database has stored therein patent application information associated with published/unpublished PCT patent applications and/or National patent applications. The server computer generates data indicative of an interactive Internet website for worldwide promoting and offering for sale or license the PCT national/regional phase patent application rights associated with the published/unpublished unexpired PCT patent applications and/or the National patent application rights and priority rights under the Paris convention (and corresponding domestic patent laws) associated with the National patent applications.

### CROSS-REFERENCE TO RELATED APPLICATIONS

This application is a National Stage filing of International Application No. PCT/CA2016/000148 filed May 17, 2016, which claims priority of Canadian Patent Application No. 2,892,782 filed May 22, 2015; Canadian Patent Application No. 2,905,362 filed Sep. 23, 2015; Canadian Patent Application No. 2,909,107 filed Oct. 19, 2015; Canadian Patent Application No. 2,909,275 filed Oct. 19, 2015; Canadian Patent Application No. 2,909,336 filed Oct. 19, 2015; Canadian Patent Application No. 2,909,337 filed Oct. 19, 2015; Canadian Patent Application No. 2,911,065 filed Nov. 3, 2015; Canadian Patent Application No. 2,911,128 filed Nov. 3, 2015; and Canadian Patent Application No. 2,914,588 filed Dec. 10, 2015, all of which are incorporated herein by reference in their entireties.

### FIELD

The present invention relates a method and system for promoting and offering for sale or license patent rights and patent application rights, and more particularly, to an Internet based method and system for worldwide promoting and offering for sale or license patent rights, national and regional phase patent application rights associated with published/unpublished unexpired international patent applications filed under the Patent Cooperation Treaty (referred to herein as “PCT patent applications”), and/or National patent application rights and priority rights under the Paris Convention for the Protection of Industrial Property (referred to herein as the “Paris convention”) and the domestic patent laws of the countries to which the Paris convention applies giving effect to the Paris convention.

### BACKGROUND

Every year, approximately 200,000 new PCT patent applications are filed on a world-wide basis, legally reserving potential patent rights in more than 140 countries around the world for up to 30/31 (or 42 in case of Canada, upon payment of an additional fee) months (collectively referred to herein as the “30/31 month deadline”, which deadline is calculated from the International filing date, or the earliest priority date, if applicable).

However, at the end of the 30/31 month deadline, these potential rights expire to the extent that the owner does not “enter” the “national phase” (or in some cases, the “regional phase”) in one or more countries (“entering the national/regional phase” means converting the PCT patent application into a national/regional patent application in a country/region, which patent application is sometimes referred to hereinafter as a ‘PCT national/regional phase patent application’).

In other words, when a person files a PCT patent application, that patent application does not itself result in patents in each of the Patent Cooperation Treaty (“PCT”) member countries, it merely gives the owner the right to convert the PCT patent application into one or more PCT national/regional phase patent applications (that directly or indirectly cover the PCT member countries). The PCT patent application itself does not continue to be processed after the 30/31 month deadline expires, its usefulness expiring at the conclusion of the 30/31 month deadlines.

Converting a single PCT patent application into national phase applications in each of the 148 PCT member countries is expensive (the fees per country generally include local government fees, local attorney charges, domestic attorney charges, and where required, translation charges).

As a practical matter, owners often tend to choose fewer than 5 to 10 countries or regions, the remaining countries and regions often being relatively too expensive for that owner, as a result of which potential patent rights expire in many countries and regions, unless these potential patent rights are sold prior to the expiration of the 30/31 month deadline to a party interested in completing the national/regional phase entry for that/those countries in order to capitalize on the patent rights in that/those countries.

In order to finance their research, universities or large research and development firms offer their technology to the public by way of auction and/or the Internet. Furthermore, some firms offer technology for sale, for example, by advertising the same on their website.

One such tool is FlintBox® developed in 2003 by the University of British Columbia and acquired by Wellspring in 2010 enabling marketing of: new technologies, creative works, course materials, and innovative ideas. FlintBox® provides a potential buyer or investor with a bulletin board style search of posted short descriptions of new technologies, creative works, course materials, and innovative ideas.

However, FlintBox® is not capable of relevant, focused querying of technology that is subject of an unexpired PCT patent application and that is: in a specific technology classification such as, for example, patent classifications; and/or; for which PCT patent application the owner is offering for sale the national phase rights in a country or countries; and/or; where at least one of the claims in the PCT patent application is considered patentable according to the Written Opinion of the International Search Authority.

Furthermore, discouraged by the high cost to obtain and maintain a plurality of patents or patent applications in different countries or regions, the owner of intellectual property rights in an invention may have only filed a national patent application in one or two, or a small number of countries.

It may be desirable to provide an Internet based method and system for worldwide promoting and offering for sale or license PCT national/regional phase patent application rights associated with published/unpublished unexpired PCT patent applications and/or national patent application rights and priority rights under the Paris convention (and corresponding domestic patent laws) associated with National patent applications.

It also may be desirable to provide an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications that enables a potential buyer or licensee to access the relevant information using simple or sophisticated queries.

It also may be desirable to provide an Internet based method and system for worldwide promoting and offering for sale or license PCT national/regional phase patent application rights associated with published/unpublished unexpired PCT patent applications that enables a potential buyer or licensee to access the published PCT patent application, the Search Report, and the Written Opinion.

It also may be desirable to provide an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications that enables a seller or licensor to post the relevant information in a substantially quick and simple fashion.

### SUMMARY

Accordingly, one aspect of the present invention can be to provide an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications.

Another aspect of the present invention can be to provide an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications that enables a potential buyer or licensee to access the relevant information using simple or sophisticated queries.

Another aspect of the present invention can be to provide an Internet based method and system for worldwide promoting and offering for sale or license PCT national/regional phase patent application rights associated with published/unpublished unexpired PCT patent applications that enables a potential buyer or licensee to access the published PCT patent application, the Search Report, and the Written Opinion.

Another aspect of the present invention can be to provide an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications that enables a seller or licensor to post the relevant information in a substantially quick and simple fashion

According to one aspect of the present invention, there is provided an Internet based method and system for worldwide promoting and offering for sale or license PCT national/regional phase patent application rights associated with published PCT patent applications. The method provides a substantially user-auto-populatable and fully searchable internet-based marketplace advising the world of the availability for sale/license, and asking price, for PCT patent application rights in countries around the world. The method also provides the potential buyer with links or access to the actual PCT patent application as filed with the International Patent Office, the Search Report and Written Opinion of the International Search Authority (where available), and the opportunity to link to promotional video, images, or animations that are relevant to the technology (the Written Opinion of the International Search Authority is a formal and written assessment and analysis of whether the technology claimed in the PCT patent application, in the opinion of an independent and respected Authority, has novelty, inventive step and industrial applicability). This gives potential buyers an unbiased 3rd party assessment of the likelihood that the technology in the PCT patent application is patentable. The technology is fully, and easily searchable (by owner, or technology, or classification, or inventor, and other useful/relevant criteria). Optionally, this includes search analysis tools that will allow the user to identify relevant opportunities where the owner clearly has faith in the technology, but hasn't fully converted the opportunity (for example, whether the owner has chosen to enter the US, Europe (expensive), and Japan (expensive), but has not chosen Canada, or Australia, or India, indicating potentially attractive opportunities in those markets).

According to another aspect of the present invention, there is provided a method for worldwide promoting and offering for sale or license patent application rights. A server computer is connected to the Internet. A patent application database is connected to the server computer. The patent application database has stored therein patent application information associated with at least one of PCT patent applications and National patent applications. A priority rights database is connected to the server computer. The priority rights database has stored therein priority rights information associated with priority rights under at least one of: PCT; and, Paris Convention and corresponding domestic patent laws. The server computer generates data indicative of an interactive Internet website for worldwide promoting and offering for sale or license patent application rights. The interactive Internet website enables communication between the server computer and users of client computers connected to the Internet. The server computer receives from a first user, via the Internet website executed on a first client computer, a first request for providing information indicative of patent applications based on user selected search criteria presented to the first user via the Internet website. The server computer searches the patent application database in dependence upon the request and provides the information to the first client computer. The information comprising sale or license information indicative of at least a country or region for which the patent application rights are offered for sale or license and at least a time limit of availability associated therewith. The information is determined based on the patent application information and the priority rights information. The first client computer displays the information in a human comprehensible form via the Internet website executed thereon.

According to another aspect of the present invention, there is provided a system for worldwide promoting and offering for sale or license patent application rights. The system comprises a patent application database having stored therein patent application information associated with at least one of PCT patent applications and National patent applications and a priority rights database having stored therein priority rights information associated with priority rights under at least one of: PCT; and, Paris Convention and corresponding domestic patent laws. A server computer is connected to the Internet, to the patent application database, and to the priority rights database. The server computer generates data indicative of an interactive Internet website for worldwide promoting and offering for sale or license patent application rights. The interactive Internet website enables communication between the server computer and users of client computers connected to the Internet. The server computer receives from a first user, via the Internet website executed on a first client computer, a first request for providing information indicative of patent applications based on user selected search criteria presented to the first user via the Internet website. The server computer searches the patent application database in dependence upon the request and provides the information to the first client computer. The information comprises sale or license information indicative of at least a country or region for which the patent application rights are offered for sale or license and at least a time limit of availability associated therewith. The information is determined based on the patent application information and the priority rights information. The server computer provides the information to the first client computer for displaying the same in a human comprehensible form via the Internet website executed thereon. The server computer receives from a second user, via the Internet website executed on a second client computer connected to the Internet, a posting request for posting patent application information associated with a patent application for worldwide promoting and offering for sale or license patent application rights associated with the patent application and provides posting information to the second client computer for displaying the same in a human comprehensible form via the Internet website executed thereon. The displayed posting information prompts and enables the second user to provide information indicative of one of: a) a PCT patent application number or PCT publication number associated with a published PCT patent application; b) a PCT patent application number associated with an unpublished PCT patent application; and, c) a National patent application number associated with a National patent application. In a) the server computer retrieves from a WIPO website connected to the Internet the PCT patent application information in dependence upon the PCT patent application number or the PCT publication number. In b) the displayed posting information displays a message indicating that the PCT patent application has not yet been published and suggests filing a publication request or prompts and enables the second user to upload the PCT patent application information. In c) the displayed posting information prompts and enables the second user to upload the National patent application information.

An advantage of the present invention is that it provides an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications.

A further advantage of the present invention is that it provides an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications that enables a potential buyer or licensee to access the relevant information using simple or sophisticated queries.

A further advantage of the present invention is that it provides an Internet based method and system for worldwide promoting and offering for sale or license PCT national/regional phase patent application rights associated with published/unpublished unexpired PCT patent applications that enables a potential buyer or licensee to access the published PCT patent application, the Search Report, and the Written Opinion.

A further advantage of the present invention is that it provides an Internet based method and system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications that enables a seller or licensor to post the relevant information in a substantially quick and simple fashion.

### BRIEF DESCRIPTION OF THE DRAWINGS

An embodiment of the present invention is described below with reference to the accompanying drawings, in which:

FIG. 1 is a simplified block diagram illustrating an Internet based system for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIG. 2a is a simplified flow diagram illustrating provision of patent application information for viewing in an Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIG. 2b is a simplified flow diagram illustrating posting of PCT patent application information in the Internet based method for worldwide promoting and offering for sale or license PCT national/regional phase patent application rights associated with published unexpired PCT patent applications according to an embodiment of the invention;

FIG. 2c is a simplified flow diagram illustrating posting of National patent application information in the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIG. 3a is a simplified block diagram illustrating a homepage of an interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIGS. 3b to 3f are simplified block diagram illustrating webpages for searching and viewing patent applications of the interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIGS. 3g to 3j are simplified block diagram illustrating webpages for posting and managing posted patent applications of the interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIG. 3k is simplified block diagram illustrating a webpage for viewing promotional information associated with a patent application of the interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIGS. 3l and 3m are simplified block diagram illustrating webpages for creating and managing seller and buyer portfolios, respectively, of the interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIG. 3n is a simplified block diagram illustrating another homepage of an interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIG. 3o is a simplified block diagram illustrating a webpage for creating and managing an account with the interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIG. 3p is a simplified block diagram illustrating a start page of an interactive Internet website of the Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention;

FIGS. 4a to 4i are screenshots of various pages of an implementation of an Internet based method for worldwide promoting and offering for sale or license PCT national/regional phase patent application rights associated with published unexpired PCT patent applications by means of the Internet according to an embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

It is noted the embodiments hereinbelow are with reference to offering for sale or license PCT national/regional phase patent application rights associated with published/unpublished unexpired PCT patent applications and National patent application rights and priority rights under the Paris Convention (and corresponding domestic patent laws of the countries to which the Paris Convention applies giving effect to the Paris Convention) associated with National patent applications by means of the Internet. The term “National patent application” will be understood hereinafter to include all formal patent applications that may be filed in a country to which the Paris Convention applies (a “Union Country”). Seller/licensor and/or buyer/licensee may perform appropriate due diligence before finalizing the sale and/or license. Seller/licensor and/or buyer/licensee may agree to terms of the sale/license such as, for example, preventing the exportation of products from that jurisdiction, or importation into another jurisdiction (such as the seller/licensor's jurisdiction). The sale/license may also be exclusive, non-exclusive or sole, and may be a “lump sum” or royalty fee based, duration based, or any combination or other standard license language.

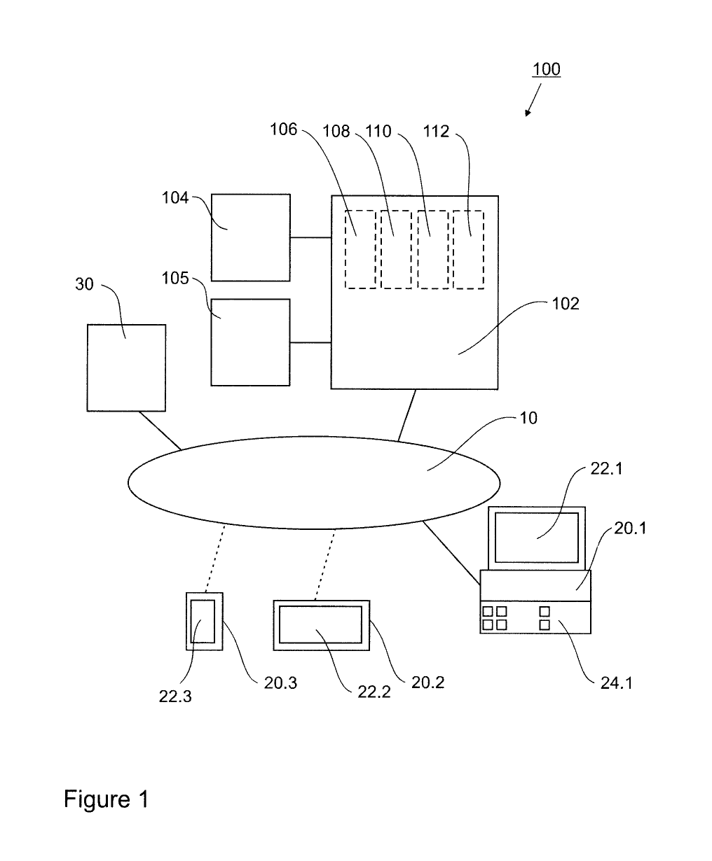

Referring to FIG. 1, an Internet based system 100 for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to an embodiment of the invention is provided. The system 100 comprises a patent application database 104 having stored therein patent application information associated with the inventions, optionally a priority rights database 105 having stored therein priority rights information associated with priority rights under PCT and the Paris Convention (and corresponding domestic patent laws), and a server computer 102 connected to the Internet 10, the patent application database 104, and the priority rights database 105 for operating an interactive Internet website and enabling access to the patent application database 104 via the interactive Internet website. The server computer 102 when executing executable commands stored in a non-transient storage medium such as, for example, a hard drive, performs the tasks of an Internet based worldwide method and system for promoting and offering for sale or license national and international patent application rights and patent rights in inventions, certain embodiments of which will be described hereinbelow, with the main tasks comprising: generating and operating an interactive Internet website; managing posting of or uploading of patent applications and related information; querying the patent application database; establishing communication links; managing user accounts; managing payments; managing posting of advertisements; and, optionally, providing machine translations of readable text files.

The database 104 is, in one case, generated and operated using a standard SQL based database management system such as, for example, MySQL, PostgreSQL, Oracle, or Sybase. The priority rights database 105 comprises: a list of the PCT countries and regions in which national/regional phase patent applications can be filed under PCT: and, a list of member countries of the Paris convention and information related to the acknowledgement of priority rights under the Paris convention (and domestic patent laws). The priority rights database 105 can be updated, for example, by a system administrator to reflect changes in the priority rights information in predetermined time intervals or upon knowledge of a change in the priority rights information. The server computer 102 is, in one case, a standard server computer capable of executing a web server application such as, for example, the widely used web server software “Apache HTTP Server”. Optionally, the server computer 102 comprises multiple processing modules with each processing module being associated with the processing of a specific task such as, for example, database management module 106, account management module 108, payment module 110, and advertisement module 112. The multiple processing modules may be implemented software based—multiple software platforms—or hardware based—multiple processors.

The interactive Internet website is, in one case, created as a dynamic website employing widely used software systems such as, for example, Common Gateway Interface (CGI), Java Servlets, or Java Server Pages. The webpages of the interactive Internet website are provided based on widely used Graphical User Interface (GUI) technology enabling the user to interact, for example, by clicking on selected icons, selecting from scroll down menus, and enter text into text fields. In one embodiment, the interactive Internet website enables provision of “multimedia” such as, for example, audio, video, and animation, employing widely used Web browser plugins such as, for example, Adobe Flash, Adobe Shockwave, Microsoft Silverlight, and applets written in Java, or HTML 5 which includes provisions for audio and video without plugins. Further in one case, the interactive Internet website is adapted to enable communication with users of various different types of client computers having Internet 10 connectivity such as, for example, desktop and laptop computers 20.1 having monitor 22.1 and keyboard 24.1, tablet computers and Personal Digital Assistants (PDAs) 20.2 having touchscreen 22.2, and smartphones 20.3 having touchscreen 22.3. The interactive Internet website may be implemented for mobile devices such as, for example, tablet computers, PDAs, and smartphones using Mobile App technology. Further in one case, the interactive Internet website is adapted to enable access to information such as, for example, promotional information of a patent application that is available from a different Internet domain 30 than the server 102—such as, for example, the web server of a company posting patent applications for worldwide promoting and offering for sale or license national and international patent application and patent rights, video sharing websites such as YouTube, or the patent database of the World Intellectual Property Organization WIPO—connected to the Internet 10 using, for example, widely used hyperlinking technology.

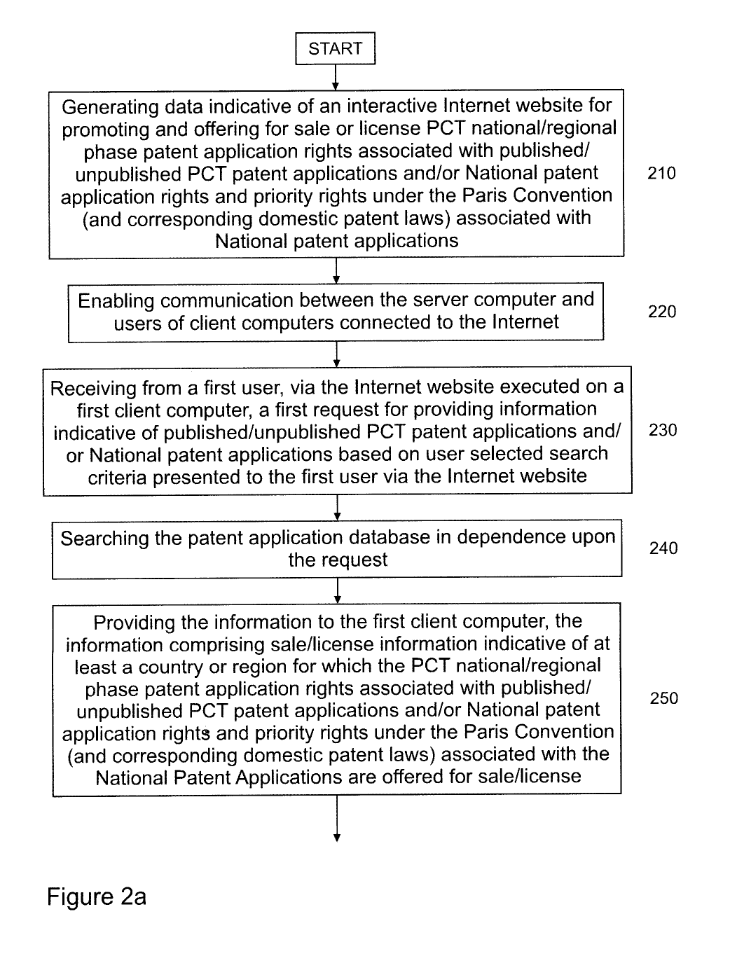

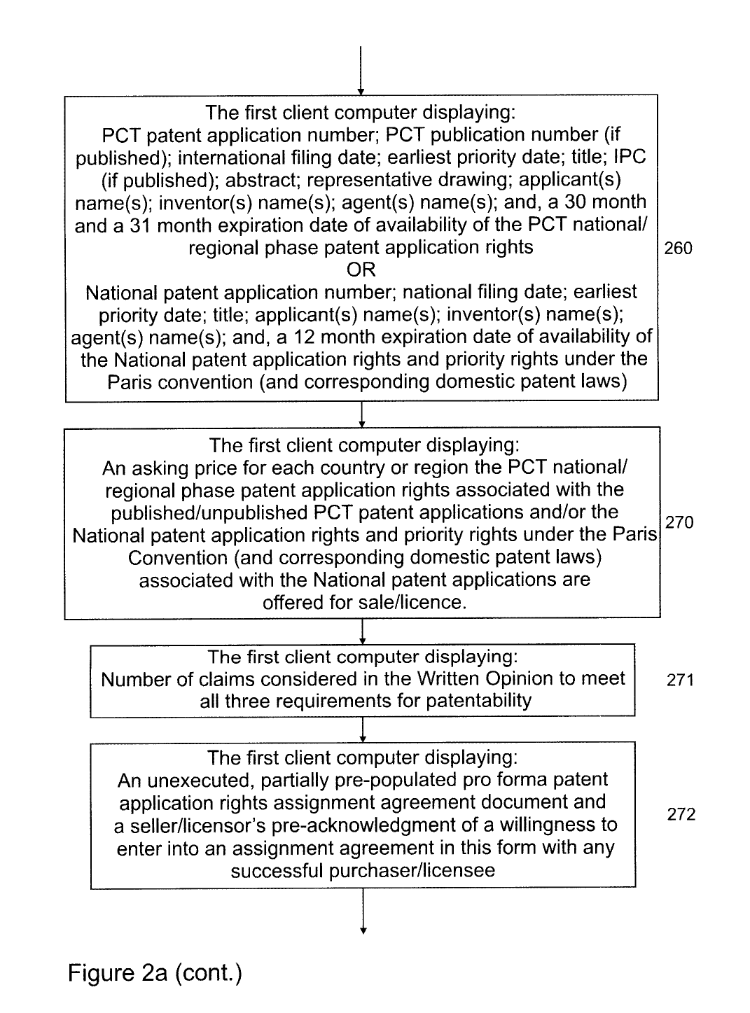

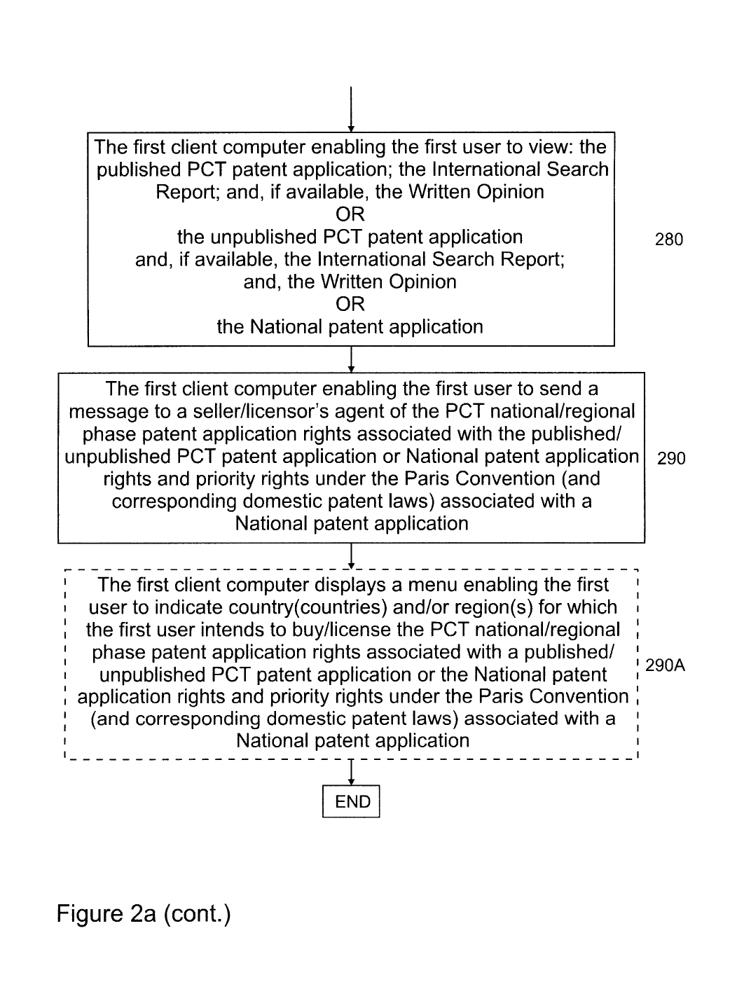

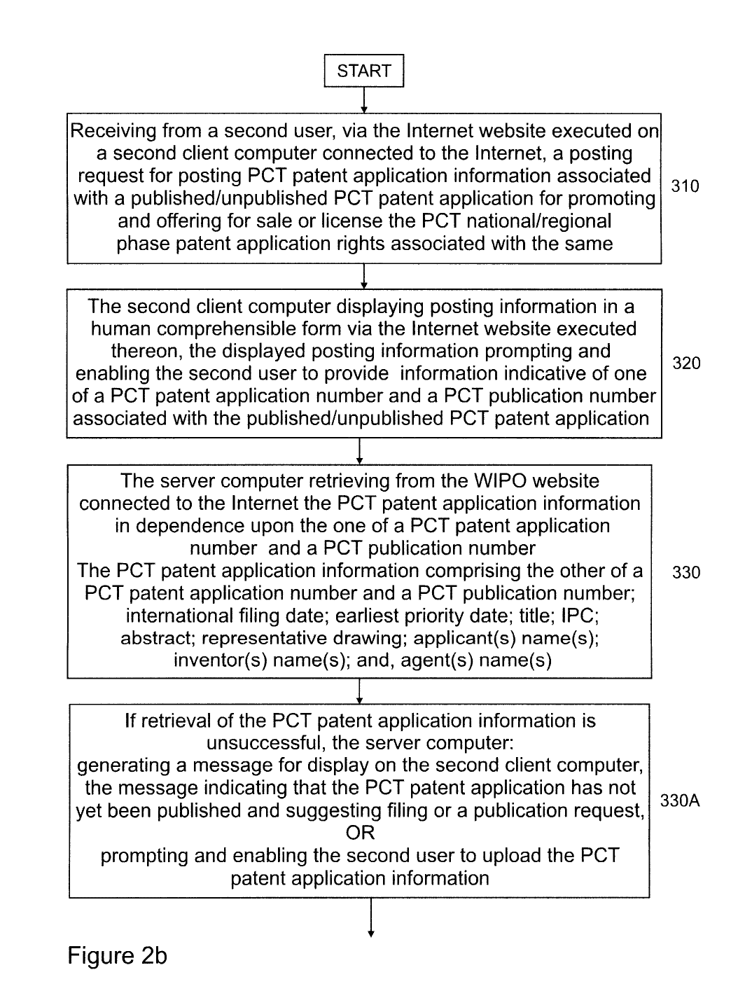

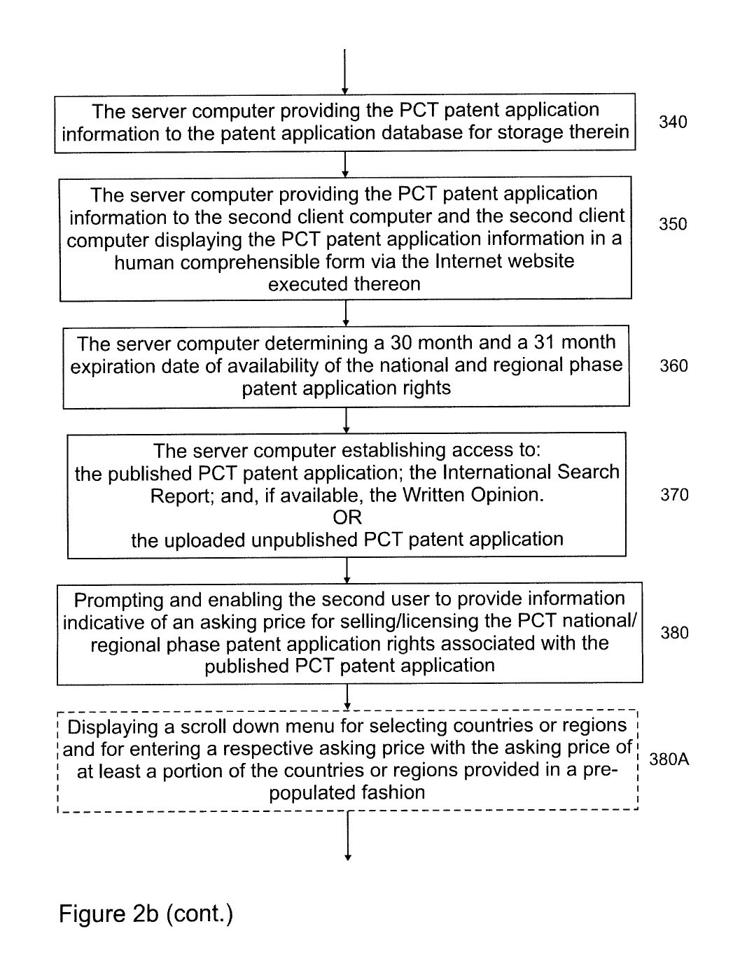

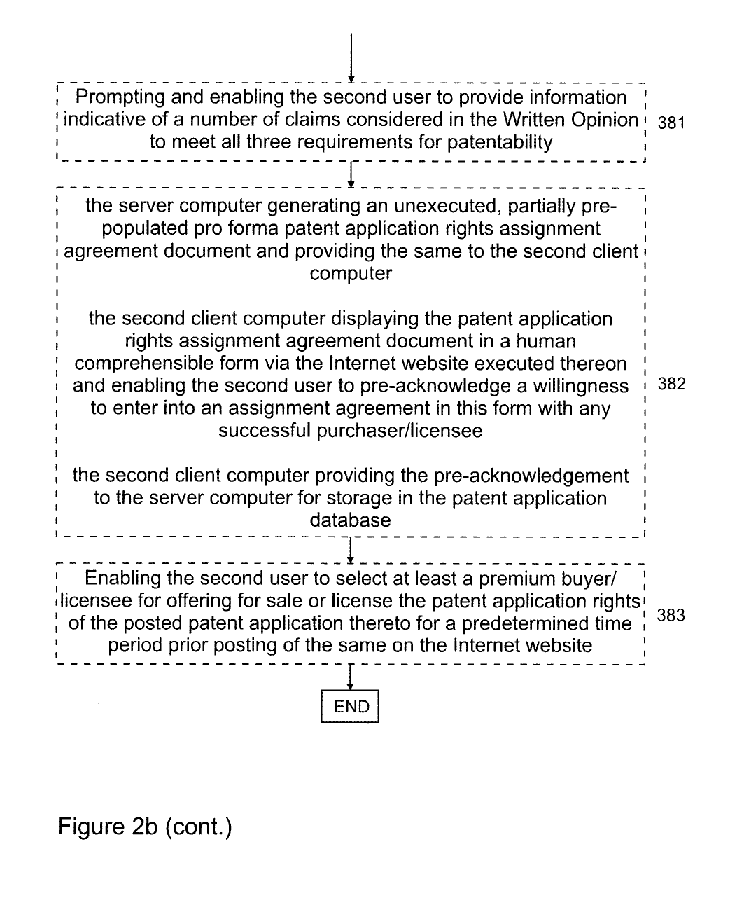

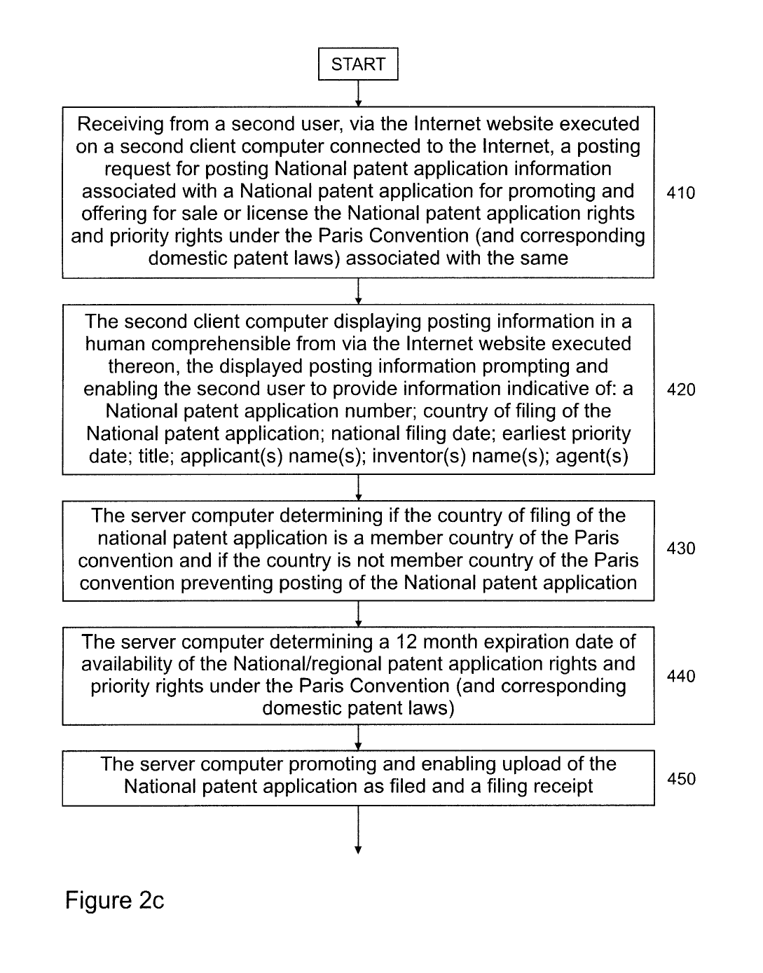

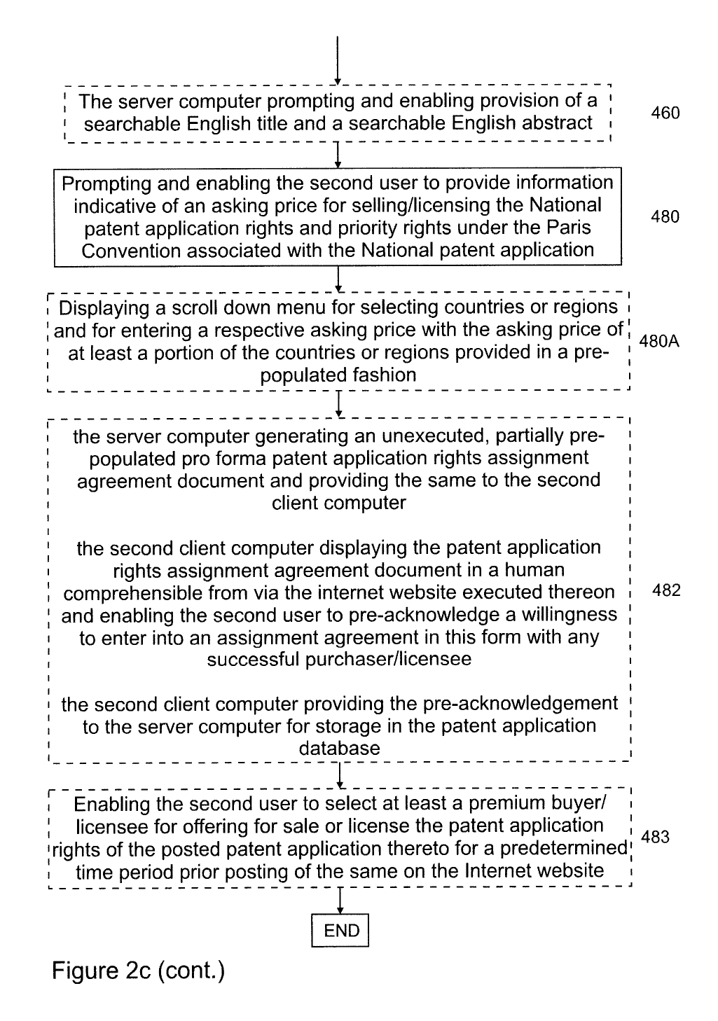

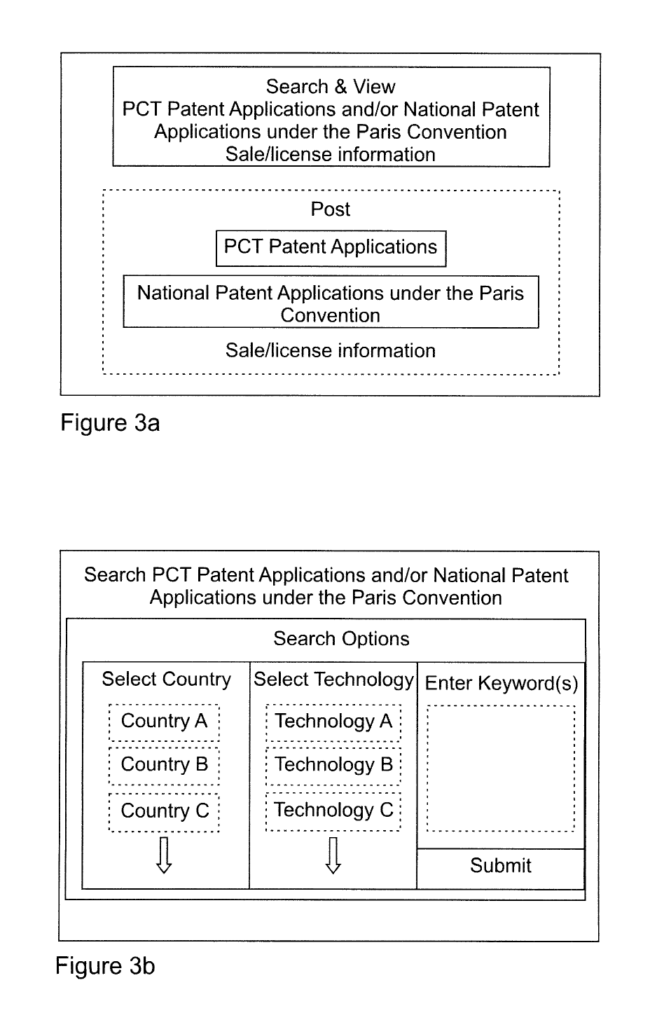

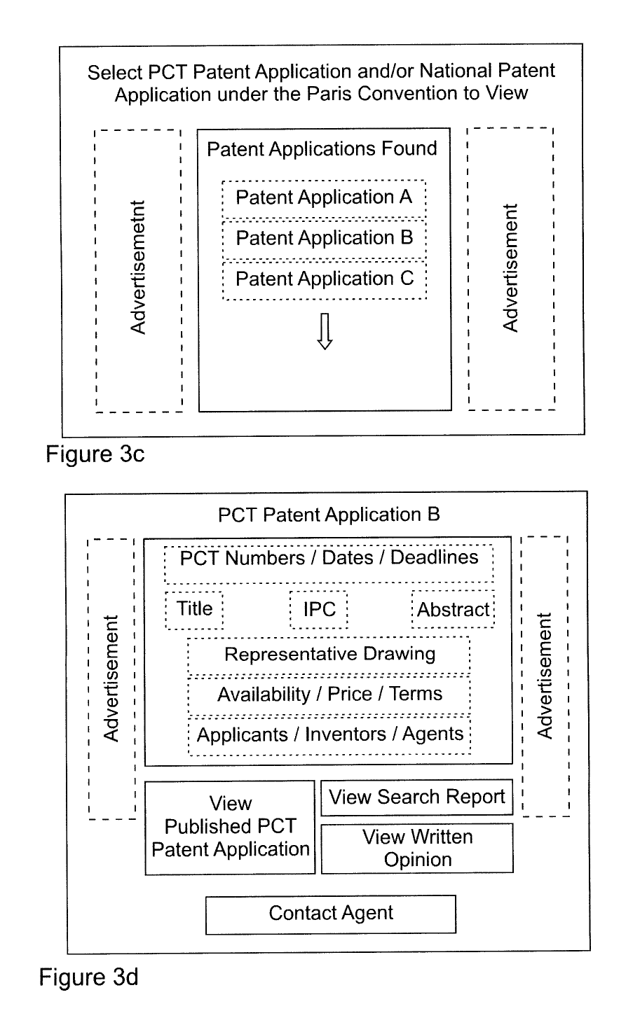

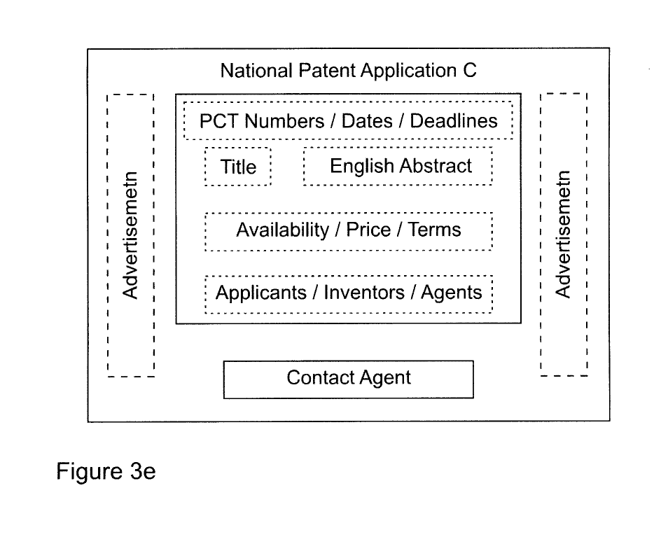

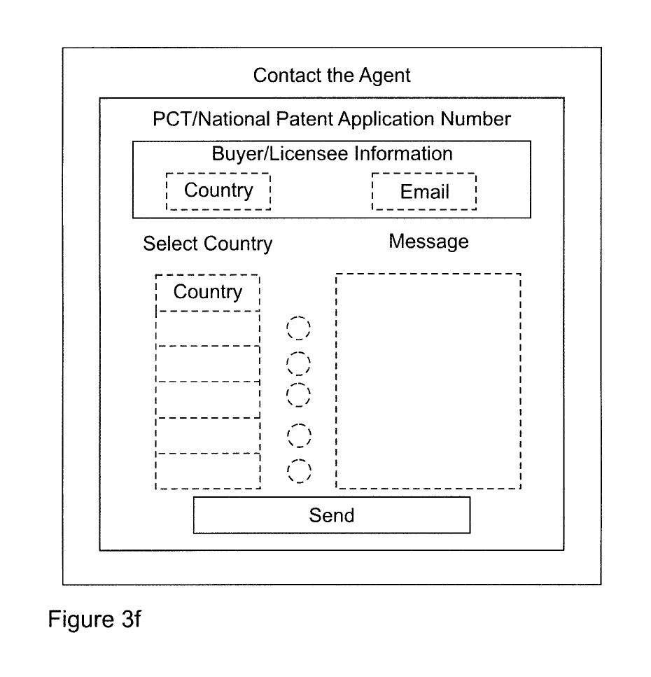

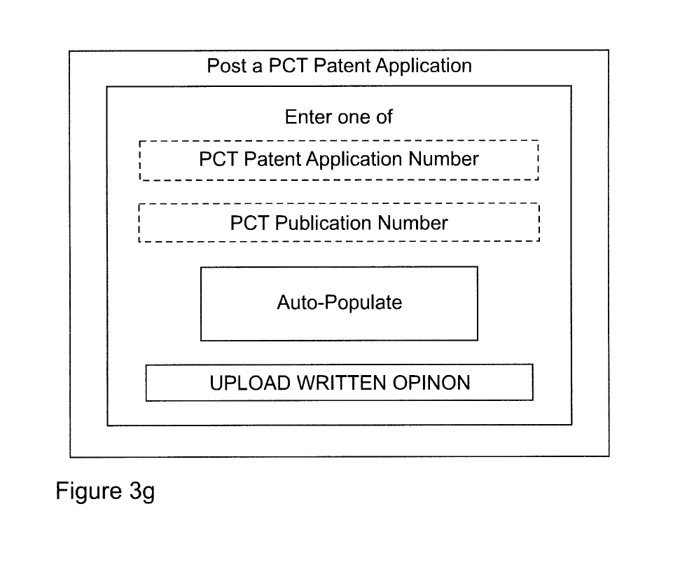

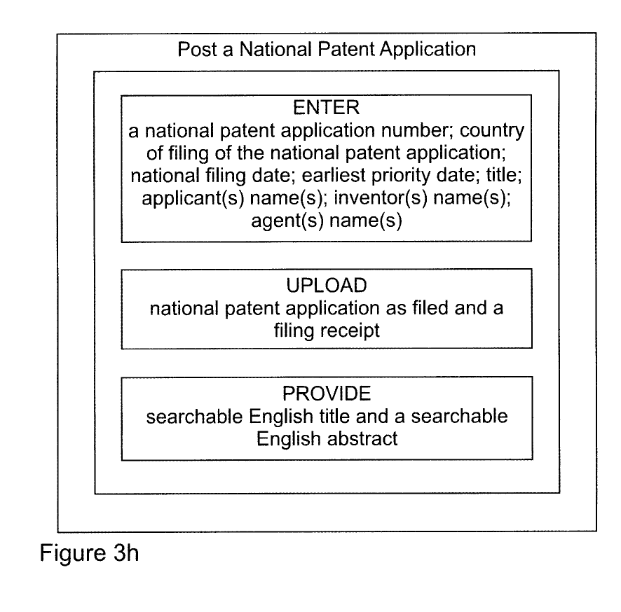

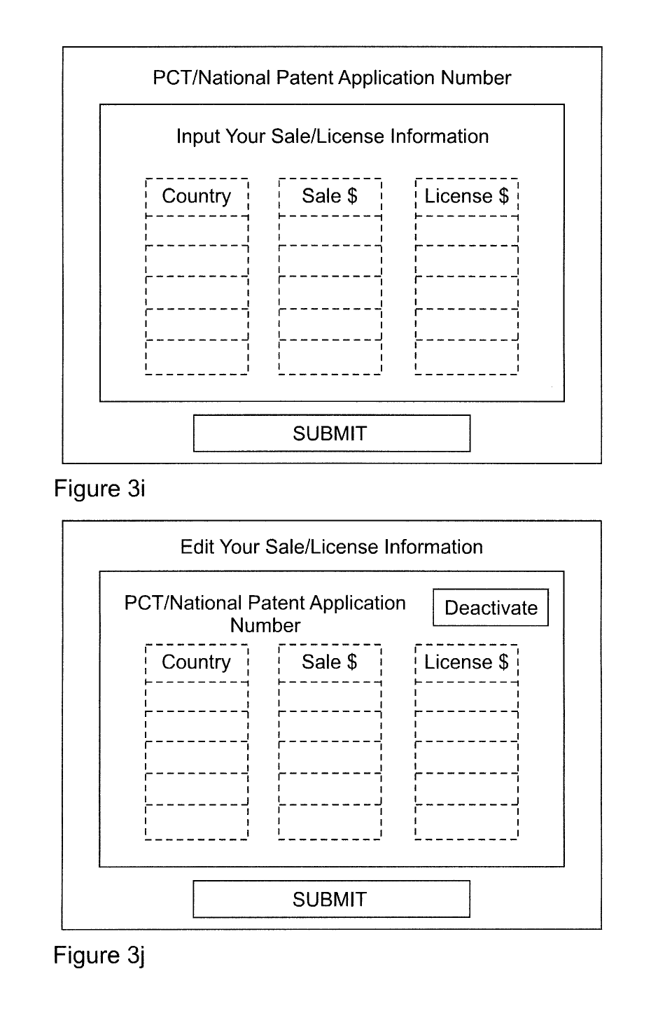

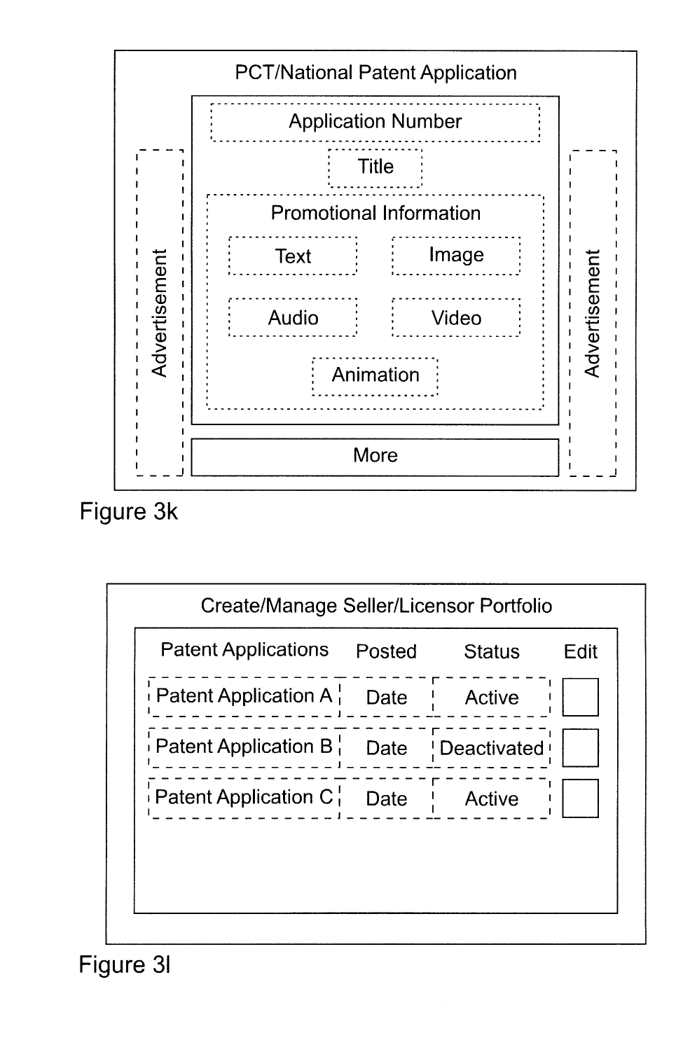

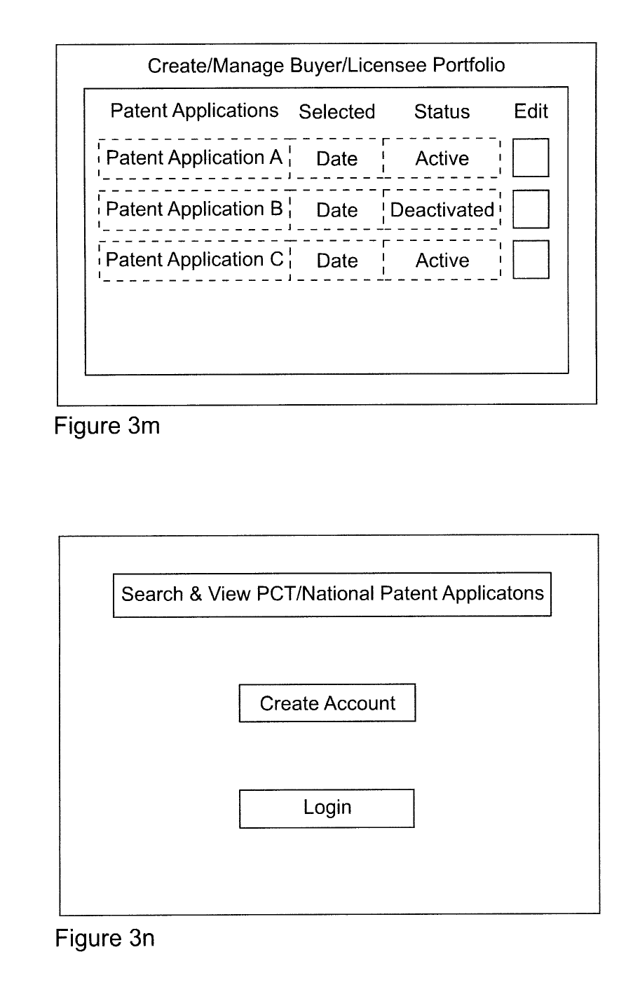

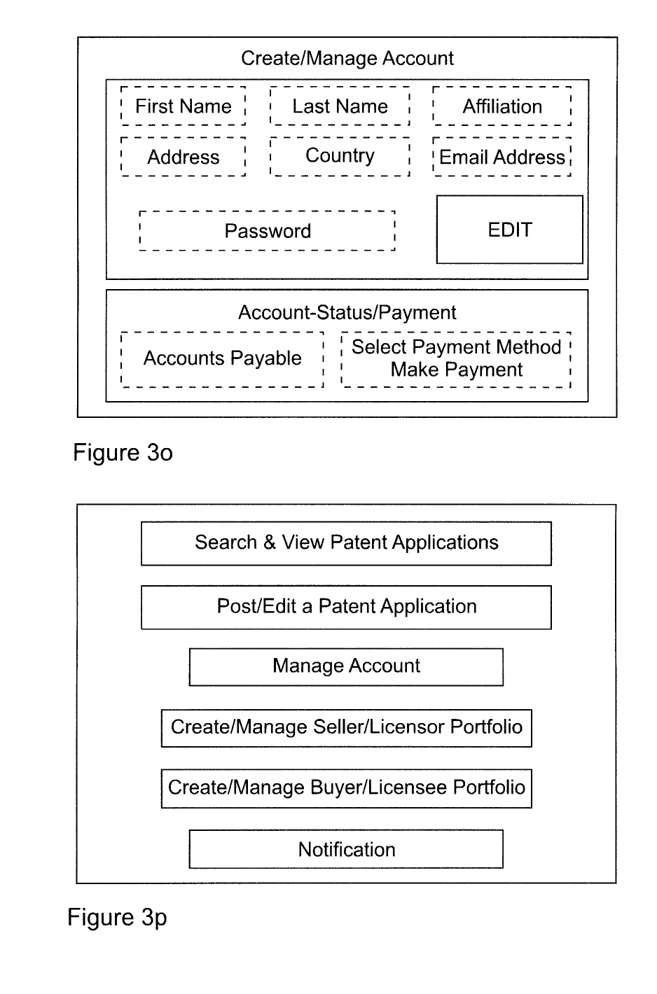

Referring to FIGS. 2a to 2c and 3a to 3p, an Internet based method for worldwide promoting and offering for sale or license PCT national/regional phase patent application rights associated with published/unpublished unexpired PCT patent applications and/or National patent application rights and priority rights under the Paris convention (and corresponding domestic patent laws) associated with National patent applications according to a first embodiment of the invention is provided. The server computer 102 generates —210—data indicative of an interactive Internet web site for promoting and offering for sale or license the PCT national/regional phase patent application rights associated with published/unpublished unexpired PCT patent applications and/or the National patent application rights and priority rights under the Paris convention (and corresponding domestic patent laws) associated with National patent applications. The interactive Internet website enables —220—communication between the server computer 102 and users of client computers 20.1-20.3 connected to the Internet 10. When accessing the interactive Internet website via one of the client computers 20.1-20.3, the user is presented with a homepage, as illustrated in FIG. 3a, enabling: a potential buyer to select the ‘Search and View’ option for searching and viewing posted unexpired PCT patent applications, national patent applications, or both, sale/license information, and other relevant information; and, a seller to select the ‘Post’ option for posting unexpired PCT patent applications or National patent applications, by clicking on the button associated with the respective option.

After clicking on the ‘Search & View PCT Patent Applications and/or National Patent Applications under the Paris Convention’ button, the user is presented with a webpage such as illustrated in FIG. 3b providing various search options for searching the patent application database 104 such as, for example, optionally selecting search of: PCT patent applications only; National patent applications only; or both, selecting a country or countries for which the national and international patent application and patent rights are offered for sale or license from countries listed—for example, in alphabetical order in a scroll down menu—selecting a technology from different technologies such as “automotive”, “construction”, “electronics”, etc. listed—for example, in alphabetical order in a scroll down menu—and by using keywords. For example, the user may select one or more countries, a technology, and further refine the search by entering one or more keywords. Further search options may include searching PCT patent applications based on patent classifications (such as, for example IPC); and/or; for which PCT patent application the owner is offering for sale or license the PCT national/regional phase rights in a country/region or countries/regions, or for which National patent application the owner is offering for sale or license the National patent application rights and priority rights under the Paris convention (and corresponding domestic patent laws) in a country/region or countries/regions; and/or; for which PCT patent application the owner is not offering for sale or license the PCT national/regional phase rights in a country/region or countries/regions, or for which National patent application the owner is not offering for sale or license the national patent application rights and priority rights under the Paris convention (and corresponding domestic patent laws) in a country/region or countries/regions; and/or; where at least one of the claims in the PCT patent application is considered patentable according to the Written Opinion of the International Search Authority.

Optionally, the user is enabled to choose further predefined database search criteria such as:
i) Geographic availability or non-availability with the latter being differentiated whether the seller/licensor chose not to make it available—indicating seller/licensor confidence and likely entry into national patent application by the seller—vs. non-availability due to sale of the national patent rights to an interested third party and indicating confirmation that the third party has provided some confirmation of its value;
ii) Name of applicant; and,
iii) Time to end of 30/31 month deadline of PCT patent applications or 12 month priority deadline of National patent applications.

After clicking the “Submit” button, the search request is provided to the server computer 102. After receipt —230—of the search request the server computer 102 searches —240—the patent application database 104 in dependence upon the search query, as illustrated in FIG. 2a, and provides —250—the search results to the client computer where they are displayed in a new webpage or window, illustrated in FIG. 3c, by listing the found patent applications, for example, sorted by country, or in order of the date of posting (or the date of the expiration of the national entry, or another user defined ordering) in a scroll down menu. The user is then enabled to select one or more of the listed patent application(s) for viewing by clicking on the respective patent application in the list.

After receiving the request for providing PCT patent application information or National patent application information related to a specific user selected PCT patent application or National patent application the server computer retrieves the information associated with the user selected PCT patent application or National patent application and provides the same to the client computer where it is displayed via the interactive Internet website displaying a new webpage or window, illustrated in FIGS. 3d and 3e, respectively. The displayed information —260—comprises: PCT patent application number; PCT publication number (if published); international filing date; earliest priority date; title; IPC (if published); abstract; representative drawing; applicant(s) name(s); inventor(s) name(s); agent(s) name(s); a 30 month and a 31 month expiration date of availability of the national and regional phase patent application rights; or National patent application number; National filing date; earliest priority date; title; applicant(s) name(s); inventor(s) name(s); agent(s) name(s); and, a 12 month expiration date of availability of the national and regional patent application rights; and, 270—an indication of the availability for license and/or an asking price for each country or region the national and regional patent application rights associated with the PCT patent application or National patent application are offered for sale/license (which may optionally also include terms of sale/license to be agreed to by the buyer or licensee).

Optionally, the webpage displays a number corresponding to the number of claims considered in the Written Opinion to meet all three requirements for patentability or an indicator indicating that at least one of the claims meet these requirements —271.

Further optionally, the webpage displays an unexecuted, partially pre-populated pro forma patent application rights assignment agreement document and a seller's pre-acknowledgement of a willingness to enter into an assignment agreement in this form with any successful purchaser —272.

By clicking on the respective button —280—the webpage enables the user to view one of:
the published PCT patent application, the Search Report of the International Search Authority, and, if available, the Written Opinion;
the unpublished PCT patent application (as posted by the seller/licensor), and, if available, the Search Report of the International Search Authority and the Written Opinion of the International Search Authority; and,
the National patent application (as posted by the seller/licensor).

The webpage also enables the user to send a message to the seller/licensor's agent of the national and regional patent application rights associated with the PCT patent application or the National patent application —290—by clicking the ‘Contact Agent’ button. The agent's contact information may be obtained from the seller/licensor when posting the PCT patent application or National patent application; or from the agent, for example, when signing up to the Internet website.

In one embodiment, after clicking the ‘Contact Agent’ button the webpage displays a menu, illustrated in FIG. 3f, enabling the user to: provide contact information; indicate country (countries) and/or region(s) for which the user intends to buy/license the patent application rights associated with the published PCT patent application —290A; and, provide a message to the agent. The information is then sent to the agent by clicking on the ‘Send’ button.

Optionally, the server computer 102 tracks the number of times a particular PCT patent application or National patent application was the subject of a displayed search result, as well as the number of times a particular PCT patent application information page or National patent application information page was displayed. The information is then displayed to all viewers of the PCT patent application or National patent application to show the interest in the PCT patent application or National patent application.

Referring to FIGS. 2b and 3g, a seller is enabled to post a published PCT patent application. After clicking —310—on the ‘Post PCT Patent Applications’ button on the webpage illustrated in FIG. 3a, the seller is presented —320—with a webpage such as illustrated in FIG. 3g prompting and enabling the seller to provide information indicative of one of a PCT patent application number or a PCT publication number associated with the published PCT patent application. After entering one of a PCT patent application number or a PCT publication number in the respective field and clicking the ‘Auto-Populate’ button, the server computer 102 retrieves —330—from the WIPO website connected to the Internet the PCT patent application information in dependence upon the one of a PCT patent application number or a PCT publication number. The PCT patent application information comprises the other of a PCT patent application number or a PCT publication number; international filing date; earliest priority date; title; IPC; abstract; representative drawing; applicant(s) name(s); inventor(s) name(s); and, agent(s) name(s). The server computer 102 provides —340—the PCT patent application information to the patent application database 104 for storage therein and —350—to the client computer for displaying the PCT patent application information in a human comprehensible form via the Internet website executed thereon. The server computer 102 also determines —360—a 30 month and a 31 month expiration date of availability of the national and regional phase patent application rights based on the PCT patent application information and the priority rights information.

In the event that the retrieval of the PCT patent application information associated with a PCT patent application number is unsuccessful —330A, the server computer 102 generates a message for display on the seller's client computer, the message indicating to check if the PCT patent application is correct, and if it is correct, indicating that the PCT patent application has not yet been published, and suggesting filing a publication request.

The server computer 102 further establishes 370—access to: the published PCT patent application; the Search Report of the International Search Authority; and, the Written Opinion of the International Search Authority. Access to the published PCT patent application and the Search Report is provided by the server computer 102 retrieving the same from the WIPO website and storing in the patent application database 104. The Written Opinion is populated from the WIPO site in a conventional manner or is uploaded by the seller/licensor or the seller/licensor's agent via the webpage, as illustrated in FIG. 3g.

The seller/licensor is also enabled to post an unpublished PCT patent application. For example, at 330A the seller/licensor or the seller/licensor's agent is prompted and enabled to provide information indicative of: PCT filing date; earliest priority date; title; applicant(s) name(s); inventor(s) name(s); and, agent(s) name(s) and agent(s) contact information, and to upload the unpublished PCT patent application and, if available, the Search Report of the International Search Authority and the Written Opinion.

Referring to FIGS. 2c and 3h, a seller is enabled to post a National patent application. After clicking —410—on the ‘Post National Patent Applications’ button on the webpage illustrated in FIG. 3a, the seller is presented —420—with a webpage such as illustrated in FIG. 3h prompting and enabling the seller to provide information indicative of: a National patent application number; country of filing of the National patent application; National filing date; earliest priority date; title; applicant(s) name(s); inventor(s) name(s); and, agent(s) name(s) and agent(s) contact information. The server computer 102 then determines —430—if the country of filing of the National patent application is a member country of the Paris convention based on the country of filing of the National patent application and the priority rights information, and if the country is not a member country of the Paris convention prevents posting of the National patent application. Optionally, the seller/licensor is provided with a message indicating why posting is prevented. The server computer 102 further determines —440—a 12 month expiration date of availability of the national patent application rights and priority rights under the Paris convention (and corresponding domestic patent laws). At 450, the server computer 102 prompts and enables upload of the National patent application as filed and optionally a filing receipt.

Optionally, if the 12 month expiration date of availability is soon to elapse, the server computer 102 determines if the country of filing of the National patent application is a PCT member country based on the country of filing of the National patent application and the priority rights information and provides a message to the seller/licensor suggesting filing a PCT patent application.

Further optionally, the server computer 102 prompts and enables provision of a searchable English title and searchable English abstract —460.

Referring to FIG. 3i, the seller/licensor is prompted and enabled to provide information indicative of an asking price (or that the price is to be negotiated) for selling or licensing the PCT national/regional phase patent application rights associated with a published/unpublished unexpired PCT patent application and/or the national patent application rights and priority rights under the Paris convention (and corresponding domestic patent laws) associated with a National patent application —380/480. For example, the seller/licensor is provided with a list of PCT member countries or Paris convention member countries and associated fields for entering the respective asking price for selling and/or licensing indicator on a country by country basis. The PCT patent application or National patent application is then posted by clicking the ‘Submit’ button.

Optionally, a scroll down menu is displayed —380A/480A—for selecting countries or regions and for entering a respective asking price with the asking price and/or availability for licensing of at least a portion of the countries or regions provided in a pre-populated fashion. For example, the seller enters an asking price for a region which is then used to pre-populate the countries of this region. Alternatively, the pre-population is done based on the asking prices of a PCT patent application or National patent application previously posted by the seller.

Optionally, in case of a PCT patent application the webpage prompts and enables the seller to provide information —381—indicative of a number of claims considered in the Written Opinion to meet all three requirements for patentability or that at least one of the claims meet these requirements.

Optionally, in case of a PCT patent application the webpage prompts and enables the seller to provide the number of references in categories ‘X’ and ‘Y’ cited in the International Search report using, for example, a scroll down menu which will be displayed, for example, together with the number of claims considered in the Written Opinion to meet all three requirements for patentability.

Optionally, the server computer 102 generates an unexecuted, partially pre-populated pro forma patent application rights assignment agreement document and provides the same to the client computer —382/482. The client computer displays the patent application rights assignment agreement document in a human comprehensible form via the Internet website executed thereon and enables the seller to pre-acknowledge a willingness to enter into an assignment agreement in this form with any successful purchaser and provides the pre-acknowledgement to the server computer 102 for storage in the patent application database 104.

Optionally, the seller is prompted to provide an indication for display to potential buyers that the user believes in the technology. For example, the user provides an indication that he has filed national or regional patent applications in Japan, Europe and/or other very expensive countries/regions. Alternatively, the user provides information regarding the investment into the implementation of the invention.

Optionally, the seller/licensor is provided with a list of premium buyer/licensees and enabled to select at least a premium buyer/licensee for offering for sale or license the patent application rights of the posted patent application thereto for a predetermined time period prior posting of the same on the Internet website, if the seller/licensor wishes to do so. For example, to be listed as a premium buyer/licensee, a buyer/licensee may pay a premium buyer/licensee fee or become a sponsor of the Internet website. The time period is, for example, determined by the seller/licensor or the Internet website operator. The premium buyer/licensee(s) selected by the seller/licensor is then provided with: a notification that the patent application rights associated with the patent application have been offered only to the premium buyer/licensee(s); and a link for accessing the patent application and the patent application information. Offering for sale or license the patent application rights of the posted patent application only to a premium buyer/licensees enables, for example, selling or licensing of the patent application rights of an unpublished patent application with the unpublished patent application becoming known only to the premium buyer/licensee(s) selected by the seller/licensor, thus preventing a competitor to gain access to the patent application until publication 18 month from the priority date.

Referring to FIG. 3j, the seller/licensor is enabled to edit data related to an already posted PCT/National patent application. For example, the seller/licensor is presented with the webpage illustrated in FIG. 3j, enabling editing the sale/license information or to deactivate the posted PCT/National patent application. The seller/licensor is presented with this webpage, for example, by entering the PCT/National patent application number of the already posted PCT/National patent application.

Optionally, the seller/licensor is enabled to provide promotional information associated with the posted PCT/National patent application for being presented to potential buyer/licensees, for example, using a link on the search result page illustrated in FIGS. 3d and 3e, respectively, to a new webpage, illustrated in FIG. 3k, displaying the promotional information using at least one of: text; image; audio; video; and, animation.

Optionally, in case of a PCT patent application the server computer 102 compares the 30 month expiration date of availability of the PCT national/regional phase patent application rights with a present date and if the comparison is indicative of elapse of availability removes the countries and regions associated with the 30 month expiration date from the sale/license information. Optionally, a notification of the removal is sent to the seller, for example, a predetermined time interval prior to the removal.

Optionally, the same is repeated for the 31 month expiration date of availability of the PCT national/regional phase patent application rights. Optionally, the server computer 102 determines if Canada is designated as a country for which the PCT national/regional phase patent application rights associated with the published PCT patent application are offered for sale/license. If Canada is not designated as a country for which the PCT national/regional phase patent application rights associated with the published PCT patent application are offered for sale/license, the server computer 102 generates a message indicating that Canada has a 42 month expiration date of availability of the PCT national phase patent application rights and can still be offered for sale/license and provides the same to the seller/licensor's client computer.

In case of a National patent application, the server computer 102 compares the 12 month expiration date of availability of the national patent application rights and priority rights under the Paris convention (and corresponding domestic patent laws) associated with the National patent application with a present date and if the comparison is indicative of elapse of availability removes the posting of the National patent application. Optionally, a notification of the removal is sent to the seller/licensor, for example, a predetermined time interval prior to the elapse of availability. Further optionally, the server computer 102 determines if the country of filing of the National patent application is a PCT member country based on the country of filing of the National patent application and the priority rights information and provides a message to the seller/licensor suggesting filing a PCT patent application.

Optionally, users are enabled to create and manage seller/licensor and buyer/licensee portfolios, as illustrated, for example, in FIGS. 31 and 3m, respectively. The portfolios list the posted/selected PCT/National patent application, the dates—for example, of posting/selecting or expiration dates—the status—for example, active, deactivated and allow the user to edit entries, for example, to change the status, by clicking on the respective button under ‘EDIT’.

The interactive Internet website can prompt users to agree to the ‘Terms and Conditions’ of the web site, for example, prior to enabling a potential buyer/licensee to select the search criteria and prior to enabling a seller to provide the PCT/National patent application number or the PCT publication number.

Optionally, the interactive Internet website is adapted for also promoting and offering for sale or license: the National patent application rights associated with respective National patent applications in the countries of filing of the respective National patent applications, for example, after the 12 month deadline; Regional patent application rights associated with respective Regional patent applications; and National/Regional Patents. The ‘Search and View’ options are easily adapted to enable a potential buyer/licensee to also search and view the additional patent applications and patents, as well as to enable a seller/licensor to post the same, for example, by providing additional buttons on the webpage illustrated in FIG. 3a and providing the seller/licensor with additional webpages similar to the webpage illustrated in FIG. 3h. Optionally, the seller/licensor is enabled to indicate the desire to post a plurality of corresponding patent applications. If this is the case, provision of the patent application information is facilitated by providing same patent application information—such as, for example, earliest priority date, applicant(s) name(s) and inventor(s) name(s)—for the plurality of corresponding patent applications in a pre-populated fashion. Further optionally, the seller/licensor is enabled to indicate if a corresponding patent exists. In case a corresponding patent exists, the seller/licensor is enabled to provide the patent information. The server computer 102 then determines Patent Prosecution Highway (PPH) co-operation availability based on the countries of filing of the National/Regional patent application, the country of filing of the corresponding patent, and PPH co-operations information associated with PPH co-operations stored in a database connected to the server computer 102. If PPH co-operation is available for a National/Regional patent application, the server computer generates data indicative thereof for provision to a potential buyer when viewing the National/Regional patent application. Optionally, the potential buyer is enabled to view the corresponding patent, for example, by providing a hyperlink to a respective database.

In one embodiment, the Internet based method for worldwide promoting and offering for sale or license PCT national/regional phase patent application rights associated with published/unpublished unexpired PCT patent applications and/or the national patent application rights and priority rights under the Paris convention (and corresponding domestic patent laws) associated with National patent applications as described hereinabove all functions are freely accessible without creating an account with the website.

In a second embodiment of the Internet based method for worldwide promoting and offering for sale or license PCT national/regional phase patent application rights associated with published/unpublished unexpired PCT patent applications and/or the national patent application rights and priority rights under the Paris convention (and corresponding domestic patent laws) associated with National patent applications according to the invention, the interactive Internet website has two levels of access. A public access level enables the user to freely search the patent application database 104 for posted PCT patent applications and/or National patent applications and view the posted PCT patent applications and/or National patent applications, while posting PCT patent applications and/or National patent applications is accessible for account holders only. The account may be free or charged, for example, on an annual basis. For example, the homepage, illustrated in FIG. 3n, enables free access for searching and viewing by clicking on the ‘SEARCH & VIEW’ button. For other functions such as posting a PCT/National patent application the user can ‘Login’ if he/she is an account holder or ‘Create an Account’, as will be described hereinbelow, by clicking on the respective buttons.

Alternatively, the user is allowed to freely search and view the PCT patent applications and/or National patent applications, but is prevented from contacting the agent unless the user is an account holder.

Further alternatively, the user is allowed to freely search and view the PCT patent applications and/or National patent applications with limited search criteria such as, for example, keyword search of title and abstract, technological field, and countries the PCT/National patent application rights are offered, and display of only promotional information, but is prevented from viewing the PCT/National patent application information, contacting the agent, and posting a PCT/National patent application unless the user is an account holder.

Further alternatively, also the searching and viewing of the PCT/National patent applications is only available for account holders.

Referring to FIG. 3m, the user is presented with the “Create/Manage Account” webpage after clicking on “Create Account” on the homepage or “Manage Account” after Login. The “Create/Manage Account” webpage enables the user to provide user account information such as First Name and Last Name of a user name, Affiliation, Address, Country, and Email Address. Further, the user is enabled to provide a Password for accessing the account. The user can be prompted to provide a ‘strong’ password in a conventional manner. Changes to any of the fields represented by the respective icons are saved by clicking the “EDIT” icon. The account may be free or charged, for example, on an annual basis.

Optionally, the “Create/Manage Account” webpage further comprises a payment section enabling the user to make secure online payments in a conventional manner via, for example, credit card or PayPal by clicking on the “Select Payment Method/Make Payment” icon. Clicking on the “Accounts Payable” icon presents the user with a list of the charges the user is required to pay such as, for example, account renewal fee, portfolio management fee, and posting fee, as will be described hereinbelow.

After clicking on the “Login” icon on the webpage illustrated in FIG. 3n, the user is provided with a typical Login window requesting provision of, for example, the account holder's user name and a password. After successful Login the account holder is presented with, for example, the webpage illustrated in FIG. 3p displaying the icons: “Search & View Patent Applications”; “Post a Patent Application”; “Manage Account”; “Manage Portfolio”; and, “Notification”, providing the user full access to the interactive Internet website, as will be described hereinbelow.

After clicking on the “Notification” button the user—for example, a member of a Technology Scouting Service or a TechScout—is presented, for example, with a list of at least one of technologies, applicants, and countries, for the user to select therefrom. The server computer 102 then sends a notification email to the email address provided by the user on the “Create/Manage Account” webpage. For example, the user is provided with an email message such as:
NOTICE TO SUBSCRIBER: The National Research Council of Canada technology titled ANTENNA DEVICE, in the field of radio electronics, is available for sale in Japan and Australia. Originally not available for sale in Canada, USA and Europe. As of the date of this NOTICE, it is not available for sale in Canada, USA, Europe and China.

There are various possibilities for the interactive Internet website to generate revenue. In one embodiment all features of the website are available for free, while revenue is generated by displaying advertisement on at least one of the webpages. For example, when displaying selected PCT patent applications banner ads of law firms are displayed therewith with the banner ads having a ‘pay-per-click’ feature resulting in a payment from the law firm to the website when the ad is clicked on and an internal ad appearing or a link to the law firm's homepage. For example, the banner ads are displayed in dependence upon a country chosen by the user.

Further revenue may be generated with the ‘Contact Agent’ button in FIGS. 3d and 3e and/or the ‘Send’ button in FIG. 3f having a ‘pay-per-click’ feature where for each click a payment is made by the seller/licensor's agent, or by buyer or licensor to the website. Optionally, server computer determines the ‘pay-per-click’ payment dependent on one of:
the number of countries chosen by the first user;
the identity of a country or countries chosen by the first user;
a total asking price of countries chosen by the first user; and,
the number of click-throughs already experienced on the PCT/National patent application (reflecting the demand, or lack thereof, for the technology).

Further sources of revenue are provided by features of the website prompting and enabling a user to provide payment information for payment of various services such as, for example:

a posting fee prior to providing the posting information;

a buyer/licensee's portfolio fee, for example, on an annual basis;

a seller/licensor's portfolio fee, for example, on an annual basis;

an account fee, for example, on an annual basis;

a notification fee, for example, on an annual basis;

a premium buyer/licensee fee, for example, on an annual basis; and,

a transaction fee to be paid by buyer/licensee at time of sale/license.

As is evident to one skilled in the art, there are numerous possibilities for combining the various options of the Internet based method for worldwide promoting and offering for sale or license PCT national/regional phase patent application rights associated with published/unpublished unexpired PCT patent applications and/or the national patent application rights and priority rights under the Paris convention (and corresponding domestic patent laws) associated with National patent applications according to the invention with the different levels of access and the different means for generating revenue.

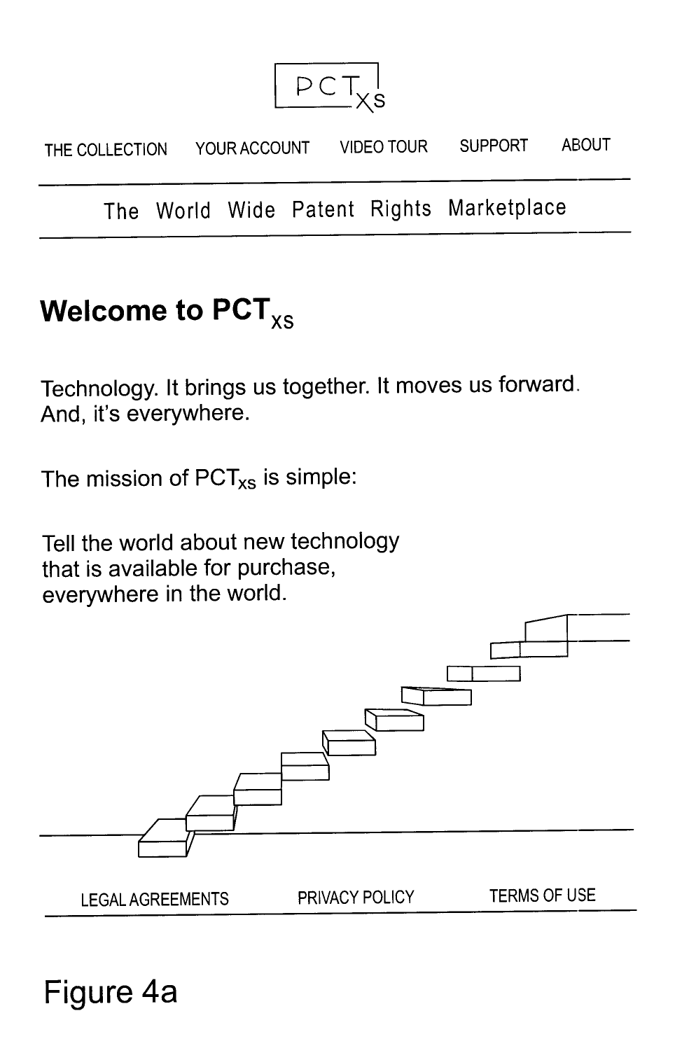

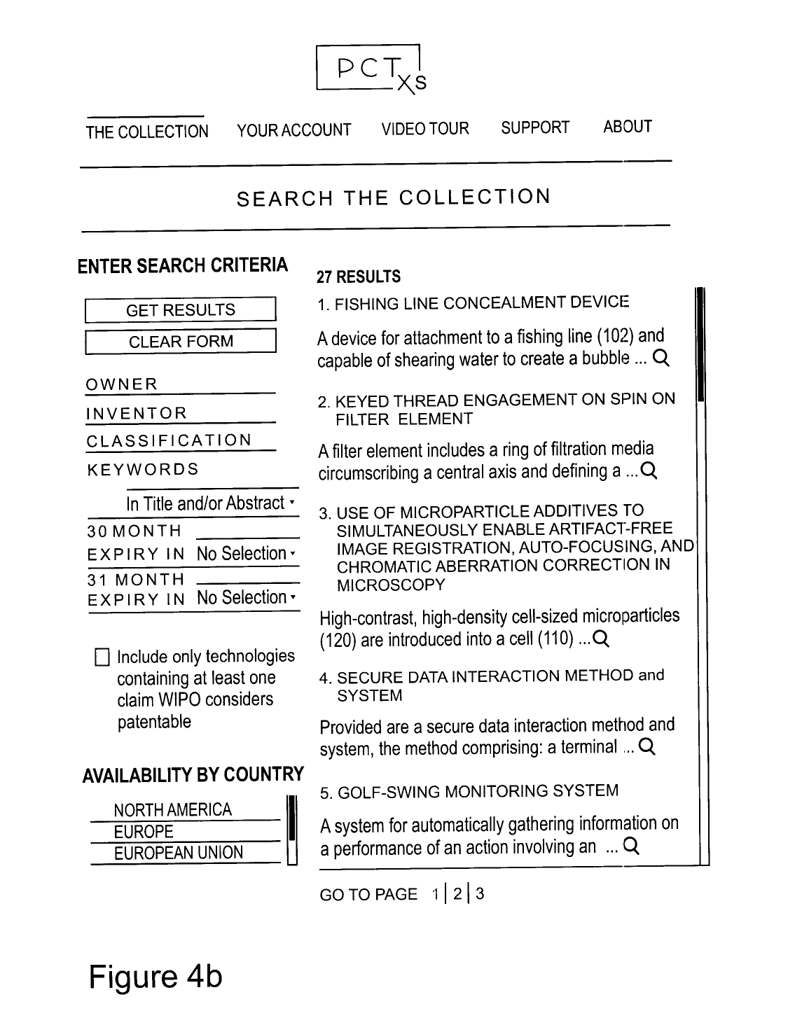

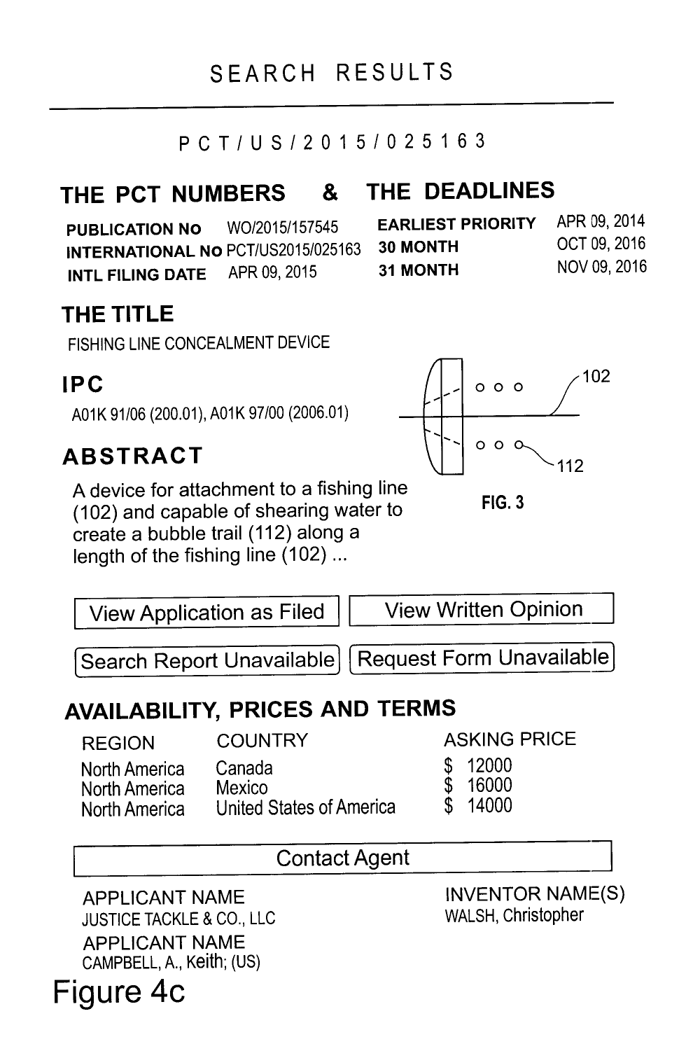

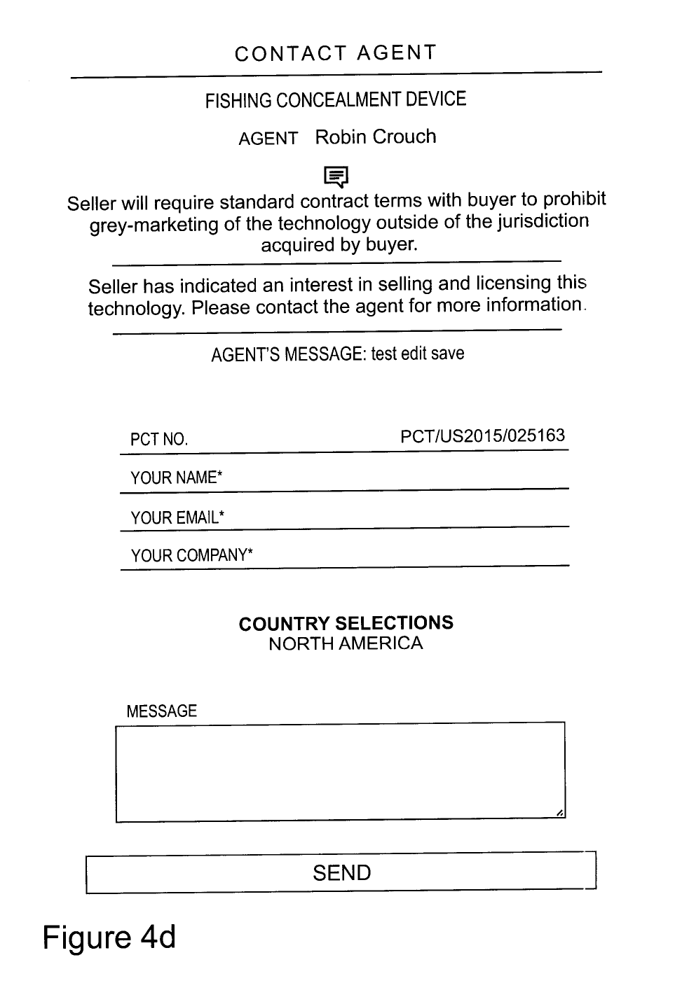

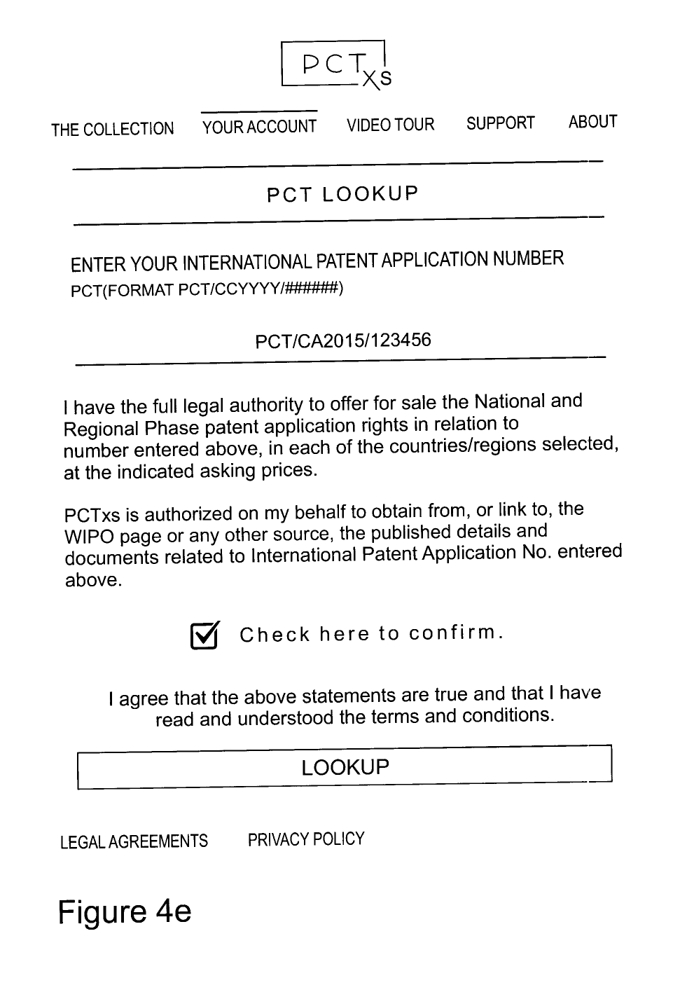

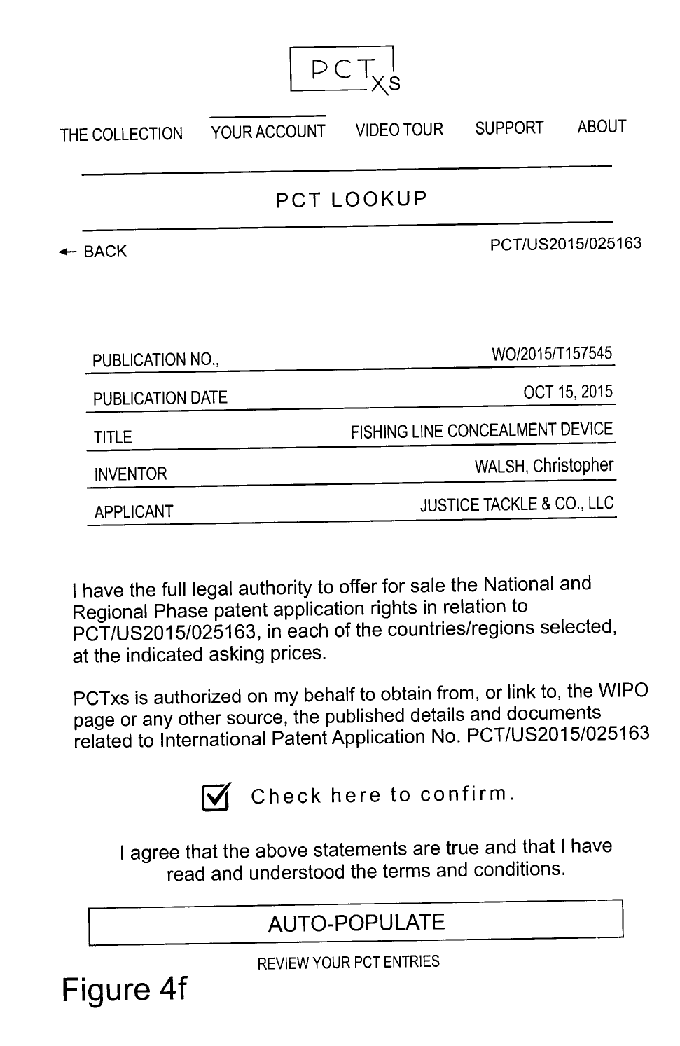

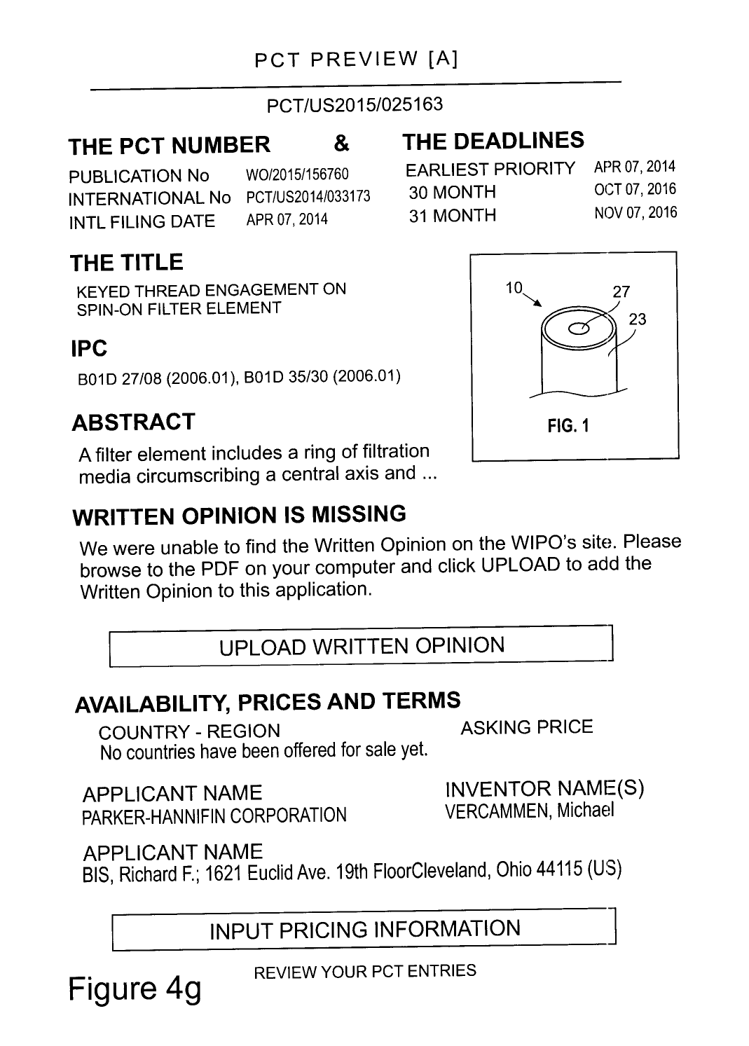

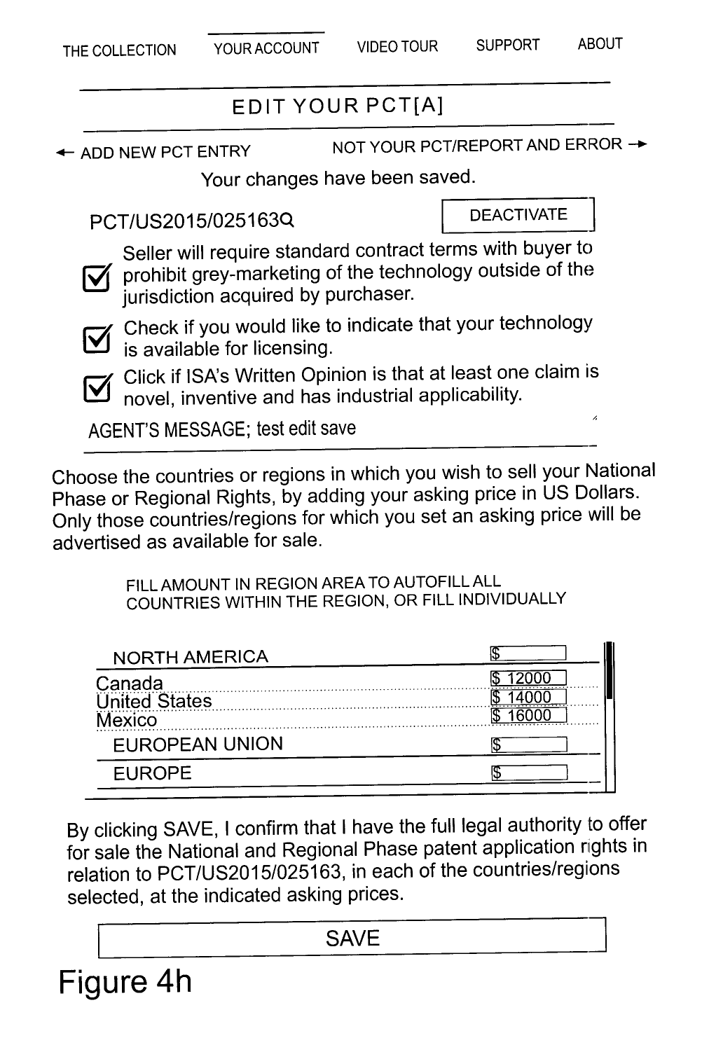

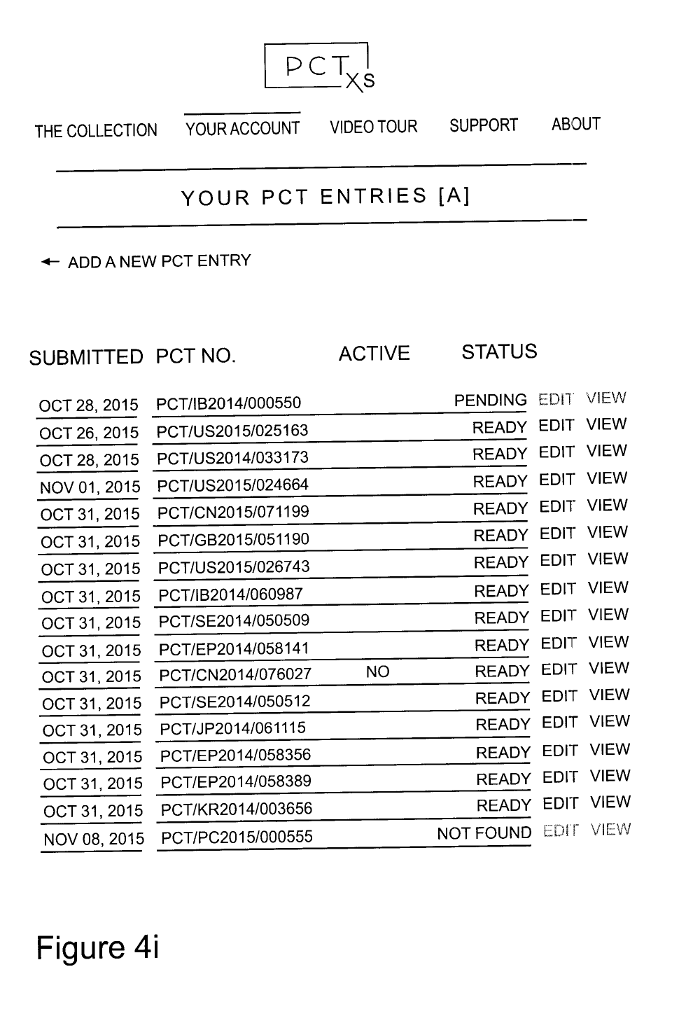

Referring to FIGS. 4a to 4i, an example implementation of the Internet based method for worldwide promoting and offering for sale or license PCT national/regional phase patent application rights associated with published unexpired PCT patent applications according to an embodiment of the invention is provided. FIG. 4a illustrates the ‘start/home’ page of the website called ‘PCTxs’. Looking at the ‘search’ page, illustrated in FIG. 4b, the search criteria are entered in the left hand column, while the search results are presented in the right hand column after clicking the GET RESULTS button and/or are presented immediately and are constantly updated as additional search terms are added. Clicking on the right arrow associated with a specific search result, or title thereof, immediately takes the user to the detail search ‘results’ page, illustrated in FIG. 4c. An interested buyer is enabled to establish communication by clicking the CONTACT AGENT button—which may have implemented the pay-per-click feature as described hereinabove—leading to the ‘contact the agent’ page, illustrated in FIG. 4d, providing information about the contact agent as well as enabling the user to select countries of interest and to send a message to the contact agent. The seller is enabled to post patent rights for sale in a PCT patent application using the ‘PCT Lookup’, illustrated in FIGS. 4e and 4f After entering the PCT application number in the ‘Lookup’ page, illustrated in FIG. 4e, the respective PCT patent application information comprising PCT numbers, publication date, title, applicant, inventor is retrieved and displayed on a new webpage, illustrated in FIG. 4f, after confirming and clicking the AUTO-POPULATE button the respective PCT patent application and data associated therewith is retrieved from a database by. For example, access to the PCT patent application and data is established by providing a hyperlink to the respective PCT patent application at the WIPO website, the contact agent has established a database containing the PCT patent applications of his clients, or the PCT patent application is retrieved manually using the ‘Patentscope’ search engine on the WIPO website. Successful retrieval is confirmed and the PCT application and data are presented on the ‘PCT Preview’ page, illustrated in FIG. 4g, where the seller is enabled to upload the Written Opinion and linked to the ‘EDIT YOUR PCT’ page, illustrated in FIG. 4h, where the seller/licensor is enabled to input the asking price for various countries. For example, the countries are presented by regions such as North America. Clicking on a region then presents the different countries of the region. The page may comprise a default prepopulate feature. For example, the seller/licensor provides an asking price and/or licensing availability for the region, which is then used to prepopulate all countries of the region with this asking price. The seller/licensor then may or may not change the preset asking price for one or more countries. Optionally, the page is prepopulated using asking prices previously provided by the seller for a different patent application. Further optionally, a running total for each region is calculated and displayed. After clicking the SUBMIT button the seller is presented with a confirmation. The ‘EDIT YOUR PCT’ page also enables the seller to edit any entry related to an already posted patent application, as well as to deactivate the same. The ‘YOUR PCT ENTRIES’ page, illustrated in FIG. 4i, lists the seller's posted patent applications and their status.

It is noted that, while the example implementation illustrated in FIGS. 4a to 4i is limited to published PCT patent applications, it will become evident to those skilled in the art that the functionality of the example implementation may be expanded in a similar fashion to include unpublished PCT patent applications and National patent applications.

The present invention has been described herein with regard to certain embodiments. However, it will be obvious to persons skilled in the art that a number of variations and modifications can be made without departing from the scope of the invention as described herein.

What is claimed is:

1. A method for worldwide promoting and offering for sale or license patent application rights comprising:
providing a server computer connected to the Internet;
providing a patent application database connected to the server computer, the patent application database having stored therein patent application information associated with at least one of PCT patent applications and national patent applications;
providing a priority rights database connected to the server computer, the priority rights database having stored therein priority rights information associated with priority rights under at least one of:
PCT; and,
Paris Convention and corresponding domestic patent laws;
the server computer generating data indicative of an interactive Internet website for worldwide promoting and offering for sale or license patent application rights, the interactive Internet website enabling communication between the server computer and users of client computers connected to the Internet;
the server computer receiving from a first user, via the Internet website executed on a first client computer, a first request for providing information indicative of patent applications based on user selected search criteria presented to the first user via the Internet website; the server computer searching the patent application database in dependence upon the request and providing the information to the first client computer, the information comprising sale or license information indicative of at least a country or region for which the patent application rights are offered for sale or license and at least a time limit of availability associated therewith, the information being determined based on the patent application information and the priority rights information; and,
the first client computer displaying the information in a human comprehensible form via the Internet website executed thereon.

2. The method according to claim 1 wherein the first client computer displays the sale or license information comprising an asking price for each country or region the patent application rights associated with the patent application are offered for sale or license.

3. The method according to claim 1 wherein the first client computer displays an unexecuted, partially pre-populated pro forma patent application rights assignment agreement document and a seller's pre-acknowledgement of a willingness to enter into an assignment agreement in this form with any successful purchaser.

4. The method according to claim 1 wherein the first client computer enables the first user to send a message to a seller's agent of the patent application rights associated with the patent application.

5. The method according to claim 1 wherein the first client computer displays a menu enabling the first user to indicate at least one of a country and a region for which the first user intends to buy or license the patent application rights associated with the patent application.

6. The method according to claim 1 wherein the first client computer displays at least one of:
a PCT patent application number; a PCT publication number; international filing date; earliest priority date; title; IPC; abstract; representative drawing; applicant(s) name(s); inventor(s) name(s); agent(s) name(s); and, a 30 month and a 31 month expiration date of availability of the PCT national and regional phase patent application rights; and,
a national patent application number; national filing date; earliest priority date; title; applicant(s) name(s); inventor(s) name(s); agent(s) name(s); and, a 12 month expiration date of availability of the national and regional patent application rights under the Paris convention.

7. The method according to claim 1 wherein the patent application is a PCT patent application and wherein the first client computer displays a number of claims considered in the Written Opinion to meet all three requirements for patentability.

8. The method according to claim 1 wherein the patent application is a PCT patent application and wherein the first client computer enables the first user to view: the published PCT patent application; the International Search Report; and, the Written Opinion.

9. The method according to claim 1 comprising:
the server computer receiving from a second user, via the Internet website executed on a second client computer connected to the Internet, a posting request for posting patent application information associated with a patent application for worldwide promoting and offering for sale or license patent application rights associated with the patent application;
the server computer providing posting information to the second client computer; and,
the second client computer displaying the posting information in a human comprehensible form via the Internet website executed thereon.

10. The method according to claim 9 wherein the displayed posting information prompts and enables the second user to provide information indicative of one of:
a) a PCT patent application number or PCT publication number associated with a published PCT patent application;
b) a PCT patent application number associated with an unpublished PCT patent application; and,
c) a national patent application number associated with a national patent application,
wherein a) the server computer retrieves from a WIPO website connected to the Internet the PCT patent application information in dependence upon the PCT patent application number or the PCT publication number,
wherein b) the displayed posting information displays a message indicating that the PCT patent application has not yet been published and suggesting filing a publication request or prompts and enables the second user to upload the PCT patent application information, and
wherein c) the displayed posting information prompts and enables the second user to upload the national patent application information.

11. The method according to claim 10 wherein in:
a) the PCT patent application information retrieved by the server computer comprises: the other of a PCT patent application number and a PCT publication number; international filing date; earliest priority date; title; IPC; abstract; representative drawing; applicant(s) name(s); inventor(s) name(s); and, agent(s) name(s);
b) the PCT patent application information uploaded by the second user comprises: international filing date; earliest priority date; title; IPC; abstract; representative drawing; applicant(s) name(s); inventor(s) name(s); and, agent(s) name(s); and,
c) the PCT patent application information uploaded by the second user comprises: national filing date; earliest priority date; title; applicant(s) name(s); inventor(s) name(s); agent(s) name(s).

12. The method according to claim 11 wherein in a) the PCT patent application information retrieved by the server computer comprises: the published PCT patent application and the International Search Report.

13. The method according to claim 11 wherein in a) and b) the displayed posting information prompts and enables the second user to upload the Written Opinion associated with the PCT patent application.

14. The method according to claim 11 wherein in a) and b) the displayed posting information prompts and enables the second user to provide information indicative of a number of claims considered in the Written Opinion to meet all three requirements for patentability.

15. The method according to claim 11
wherein in a) and b) the server computer determines a 30 month and a 31 month expiration date of availability of the PCT national and regional phase patent application rights based on the PCT priority rights information, and
wherein in c) the server computer determines a 12 month expiration date of availability of the national and regional patent application rights based on the priority rights information under the Paris Convention and corresponding domestic patent laws.

16. The method according to claim 15 comprising the server computer comparing the 30 month expiration date of availability of the PCT national and regional phase patent application rights with a present date and if the comparison is indicative of elapse of availability removing the countries and regions associated with the 30 month expiration date from the sale or license information.

17. The method according to claim 16 comprising:
the server computer comparing the 31 month expiration date of availability of the PCT national and regional phase patent application rights with a present date and if the comparison is indicative of elapse of availability removing the countries and regions associated with the 31 month expiration date from the sale or license information;
the server computer determining if Canada is designated as a country for which the PCT national phase patent application rights associated with the published PCT patent application are offered for sale or license; and,
if Canada is not designated as a country for which the PCT national phase patent application rights associated with the published PCT patent application are offered for sale or license, the server computer generating a message indicating that Canada has a 42 month expiration date of availability of the PCT national phase patent application rights and can still be offered for sale or license; and,
the server computer providing the message to the second client computer.

18. The method according to claim 10 wherein the displayed posting information prompts and enables the second user to provide information indicative of an asking price for selling or licensing the patent application rights associated with the patent application.

19. The method according to claim 18 wherein in:
a) and b) the server computer determines at least one of a country or region available for offering for sale or license PCT national and regional phase patent application rights based on the PCT priority rights information; and,
c) the server computer determines at least one of a country and region available for offering for sale or license national and regional patent application rights based on the priority rights information under the Paris Convention and corresponding domestic patent laws.

20. The method according to claim 19 wherein the displayed posting information displays a scroll down menu for selecting the at least one of a country or region and for entering a respective asking price.

21. The method according to claim 20 wherein the displayed posting information displays the asking price of at least a portion of the countries or regions in a pre-populated fashion.

22. The method according to claim 9 comprising:
the server computer generating an unexecuted, partially pre-populated pro forma patent application rights assignment agreement document;
the server computer providing the patent application rights assignment agreement document to the second client computer;
the second client computer displaying the patent application rights assignment agreement document in a human comprehensible form via the Internet website executed thereon and enabling the second user to pre-acknowledge a willingness to enter into an assignment agreement in this form with any successful purchaser;
the second client computer providing the pre-acknowledgement to the server computer; and,
the server computer providing the pre-acknowledgement to the patent application database for storage therein.

23. The method according to claim 1 wherein the interactive Internet website prompts the first user to agree to ‘Terms and Conditions’ of the website prior enabling the first user to select the search criteria.

24. The method according to claim 1 comprising:
the server computer determining access privilege of the first user to the Internet Website; and,
the server computer enabling the first user to select the search criteria if the access privilege is indicative of account holder access.

25. The method according to claim 1 comprising:
the server computer receiving from the first user, via the Internet web site executed on the first client computer connected to the Internet, a creating account request for creating an account for accessing the Internet Web site;
the server computer providing creating account information to the first client computer; and,
the first client computer displaying the creating account information in a human comprehensible form via the Internet website executed thereon, the creating account information prompting and enabling the first user to provide user information indicative of at least a user name and contact information.

26. The method according to claim 25 comprising:
prompting and enabling the first user to provide payment information for payment of an account fee.

27. The method according to claim 25 comprising:
enabling the first user to provide a request for notification if a new patent application has been filed in accordance with user determined criteria.

28. The method according to claim 27 comprising:
prompting and enabling the first user to provide payment information for payment of a notification fee.

29. The method according to claim 1 comprising enabling the first user to create and manage a buyer's portfolio of at least one of a posted PCT patent application or national patent application selected by the first user.

30. The method according to claim 29 comprising:
prompting and enabling the first user to provide payment information for payment of a buyer's portfolio fee.

31. The method according to claim 4 wherein the first client computer displays a ‘Contact Agent’ button having a ‘pay-per-click’ feature where for each click a payment is made by the seller's agent to the website.

32. The method according to claim 4 wherein the first client computer displays a ‘Send’ button for sending a message to the seller's agent having a ‘pay-per-click’ feature where for each click a payment is made by the seller's agent to the website.

33. The method according to claim 32 wherein the server computer determines the payment dependent on one of:
the number of countries chosen by the first user;
the identity of a country or countries chosen by the first user;
a total asking price of countries chosen by the first user; and,
the number of click-throughs already experienced on the PCT patent application or national patent application.

34. The method according to claim 1, wherein the first client computer displays at least a banner ad of a law firm, the banner ad having a ‘pay-per-click’ feature resulting in a payment from the law firm to the website when clicked on and a link to the law firm's homepage.

35. The method according to claim 34 wherein the first client computer displays the banner ad in dependence upon a country chosen by the first user.

36. The method according to claim 9 wherein the displayed posting information prompts the second user to agree to ‘Terms and Conditions’ of the website prior enabling the second user to provide the information.

37. The method according to claim 9 comprising:
the server computer determining access privilege of the second user to the Internet Website; and,
the server computer providing the posting information to the second client computer if the access privilege is indicative of account holder access.

38. The method according to claim 37 comprising:
the server computer prompting and enabling the second user via the Internet website to provide payment information for payment of a posting fee prior to providing the posting information to the second client computer.

39. The method according to claim 9 comprising enabling the second user to create and manage a seller's portfolio of at least one of a posted PCT patent application or national patent application posted by the second user.

40. The method according to claim 39 comprising:
prompting and enabling the second user to provide payment information for payment of a seller's portfolio fee.

41. The method according to claim 9 wherein the displayed posting information enables the second user to select at least a premium buyer for offering for sale or license the patent application rights of the posted patent application thereto for a predetermined time period prior posting of the same on the Internet website.

42. A system for worldwide promoting and offering for sale or license patent application rights comprising:
a patent application database having stored therein patent application information associated with at least one of PCT patent applications and national patent applications;
a priority rights database having stored therein priority rights information associated with priority rights under at least one of:
PCT; and,
Paris Convention and corresponding domestic patent laws;
and
a server computer connected to the Internet, to the patent application database, and to the priority rights database, the server computer performing:
generating data indicative of an interactive Internet website for worldwide promoting and offering for sale or license patent application rights, the interactive Internet website enabling communication between the server computer and users of client computers connected to the Internet;
receiving from a first user, via the Internet website executed on a first client computer, a first request for providing information indicative of patent applications based on user selected search criteria presented to the first user via the Internet website; searching the patent application database in dependence upon the request and providing the information to the first client computer, the information comprising sale or license information indicative of at least a country or region for which the patent application rights are offered for sale or license and at least a time limit of availability associated therewith, the information being determined based on the patent application information and the priority rights information;
providing the information to the first client computer for displaying the same in a human comprehensible form via the Internet website executed thereon;
receiving from a second user, via the Internet website executed on a second client computer connected to the Internet, a posting request for posting patent application information associated with a patent application for worldwide promoting and offering for sale or license patent application rights associated with the patent application; and,
providing posting information to the second client computer for displaying the same in a human comprehensible form via the Internet website executed thereon,
wherein the displayed posting information prompts and enables the second user to provide information indicative of one of:
a) a PCT patent application number or PCT publication number associated with a published PCT patent application;
b) a PCT patent application number associated with an unpublished PCT patent application; and,
c) a national patent application number associated with a national patent application,
wherein a) the server computer retrieves from a WIPO website connected to the Internet the PCT patent application information in dependence upon the PCT patent application number or the PCT publication number,
wherein b) the displayed posting information displays a message indicating that the PCT patent application has not yet been published and suggesting filing a publication request or prompts and enables the second user to upload the PCT patent application information, and
wherein c) the displayed posting information prompts and enables the second user to upload the national patent application information.

43. The system according to claim 42 wherein the server computer comprises:
a database management module for searching the patent application database in dependence upon a user request;
an account management module for managing access to the Internet website;
a payment module connected to the server computer for managing payments for services provided via the Internet website; and,
an advertisement module for managing advertisement displayed via the Internet website.
